(19) United States
(12) Patent Application Publication
(10) Pub. No.: US 2022/0159144 A1
(43) Pub. Date: May 19, 2022

(54) DOCUMENT PROCESSING DEVICE, SYSTEM, DOCUMENT PROCESSING METHOD, AND COMPUTER PROGRAM

(71) Applicant: Konica Minolta Inc., Tokyo (JP)

(72) Inventor: Tomoo YAMANAKA, Toyokawa-shi (JP)

(73) Assignee: Konica Minolta Inc., Tokyo (JP)

(21) Appl. No.: 17/452,252

(22) Filed: Oct. 26, 2021

(30) Foreign Application Priority Data
Nov. 16, 2020 (JP) 2020-190103

(51) Int. Cl. H04N 1/387; G06F 16/93; H04N 1/00

(52) U.S. Cl. CPC H04N 1/3876; H04N 1/00816; H04N 1/00803; G06F 16/93

(57) ABSTRACT

There is provided a document processing device for processing document data, and the document processing device includes a hardware processor that: acquires document data including a plurality of pieces of page data; specifies, from the document data, a common object existing at a corresponding position over a predetermined number of pieces or more of page data; and removes, when a common object is specified, the specified common object from each of the plurality of pieces of page data.

The entire disclosure of Japanese patent Application No. 2020-190103, filed on Nov. 16, 2020, is incorporated herein by reference in its entirety.

### BACKGROUND

### Technological Field

The present disclosure relates to a technique for performing processing on document data.

### Description of the Related art

Conventionally, there is used a document search system that searches for a document stored in a file server or the like, on the basis of a search condition based on a keyword designated by a user.

Further, as a method for improving searchability, there has been proposed a search system that performs, in addition to existing searching with a keyword, searching by designating, as a search condition, a user's memory of a classification (for example, a photograph, a graph, a table, and the like) of an image object other than a character, a position of an image object in a document, color information, and the like. Such a search method is referred to as an image search service. In the image search service, user's memories such as “there is a pie chart on the right side of the document” and “there is a table regarding sales on the left side of the document” can be designated as search conditions as they are.

For example, JP 2006-251864 A discloses a technique for automatically extracting a title in a document when the document is read by a scanner and digitized. An image portion where margins exceeding a required margin exist in at least three directions among upper/lower/right/left four directions is segmented from image data acquired by reading a document by a scanner, and character recognition processing of the image portion is carried out, so that a character string can be generated. When the character string includes a characteristic of a title, the character string is associated with a file of image data as a title for file management. By using this technique, for example, a document can be searched for by using “a document including a character string “about new business” as a title” as a search condition.

Here, as an example, as illustrated in FIG. 3A, in a case where a document in which a character string “Confidential” is displayed in an upper part of all the pages is set as a search target, the character string “Confidential” matches a condition for specifying a title disclosed in JP 2006-251864 A, and thus may be recognized as the title, although an original title is “about new business” in page data 131 of FIG. 3A. Therefore, there is a problem that the document illustrated in FIG. 3A is not hit even in a case where the document search is performed using “a document including a character string “about new business” as a search condition.

Further, in a case where a decorative frame is displayed at a left end of all the pages in a document, when a document is searched by using “a document in which a figure is displayed on a left side of the page” as a search condition, the document in which the decorative frame is displayed on the left side of all the pages is hit. This document is not a document desired by the user.

In order to solve this problem, there is a demand for removing unnecessary portions such as the character string “Confidential” and the decorative frame from the document.

The demand for removing unnecessary portions from the document is not limited to this case.

For example, there is a case where there are various application forms (see FIG. 26) printed in advance in a fixed format, and the application forms are provided with fields for describing an address, a name, a date of birth, and the like of an applicant. In these fields, an address, a name, a date of birth, and the like are to be written in handwriting by a user. In a case of using such an application form in a fixed format, there is also a demand for removing the fixed format portion from the application form and extracting information of a handwritten portion alone, when a certain amount of application forms are accumulated.

### SUMMARY

An object of the present disclosure is to provide a document processing device, a document processing method, a system, and a computer program capable of specifying and removing a target to be removed from document data in order to cope with the above demand

To achieve the abovementioned object, according to an aspect of the present invention, there is provided a document processing device for processing document data, and the document processing device reflecting one aspect of the present invention comprises: a hardware processor that: acquires document data including a plurality of pieces of page data; specifies, from the document data, a common object existing at a corresponding position over a predetermined number of pieces or more of page data; and removes, when a common object is specified, the specified common object from each of the plurality of pieces of page data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a system configuration diagram illustrating a configuration of a search system according to a first embodiment;

FIG. 2 is a block diagram illustrating a configuration of a document processing device;

FIG. 3A illustrates page data included in document data;

FIG. 3B illustrates a state where a superimposed image is generated by superimposing page data;

FIG. 3C illustrates a state where a common object is assessed from a superimposed image;

FIG. 3D illustrates a state of generating a superimposed image by subtracting gradation values of corresponding pixels in page data from a gradation value (initial value) of each pixel in an initial image;

FIG. 3E illustrates a state of generating a superimposed image by performing an OR operation on gradation values (binary values) of corresponding pixels in page data;

FIG. 4 illustrates an example of a superimposed image;

FIG. 5 illustrates a state of generating an image by binarizing a gradation value of each pixel in a multi-gradation image;

FIG. 6 is a block diagram illustrating a configuration of a file server device;

FIG. 7 is a flowchart illustrating a processing procedure of document data;

FIG. 8 is a flowchart illustrating a search processing procedure of document data;

FIG. 9 is a flowchart illustrating a processing procedure of document data according to a first modification of the first embodiment;

FIG. 10A is a block diagram illustrating a configuration of a document processing device of a second embodiment;

FIG. 10B illustrates a state where a label is assigned to a unit area in page data;

FIG. 11 is a flowchart illustrating a processing procedure of document data, which continues to FIG. 12;

FIG. 12 is a flowchart illustrating a processing procedure of document data;

FIG. 13A illustrates a state where an ON area label or an OFF area label is assigned to a unit area in page data;

FIG. 13B is a flowchart illustrating a procedure of label assignment;

FIG. 14A illustrates a unit area adjacent to a unit area;

FIG. 14B illustrates a circumscribed rectangle circumscribing a plurality of adjacent unit areas;

FIG. 14C illustrates a circumscribed rectangle circumscribing an image representing a character;

FIG. 15 is a flowchart illustrating a procedure of generating a circumscribed rectangular area;

FIG. 16A illustrates a state where color labels are assigned to unit areas in page data;

FIG. 16B is a flowchart illustrating a procedure of assigning a color label;

FIG. 17A illustrates a specification part of a third embodiment;

FIG. 17B illustrates a state of specifying a common object by using a character string obtained by OCR processing;

FIG. 18 is a flowchart illustrating a procedure of specifying a common object by using a character string obtained by OCR processing;

FIG. 19A illustrates a judgment part and a merging part included in a specification part in a fourth embodiment;

FIG. 19B illustrates a data structure of a special table;

FIG. 19C illustrates page number displays in respective pieces of page data;

FIG. 19D illustrates a state of merging of a common object and a non-common area;

FIG. 19E illustrates a state of merging of a common object and a non-common area;

FIG. 19F illustrates a state of merging of a common object and a non-common area;

FIG. 20 is a flowchart illustrating a procedure of merging a page number figure as a common object, and a non-common area;

FIG. 21A illustrates a configuration of a suppression part according to a fifth embodiment;

FIG. 21B is a flowchart illustrating a procedure in a case where a number of pages of document data is less than a threshold value;

FIG. 22 is a flowchart illustrating a procedure in a case where a number of pages of document data is less than a threshold value in a first modification of the fifth embodiment;

FIG. 23A illustrates a configuration of a comparison part according to a second modification of the fifth embodiment;

FIG. 23B is a flowchart illustrating a procedure in a case where a number of pages of document data is less than a threshold value in the second modification of the fifth embodiment;

FIG. 24A illustrates a state of merging in a case where a distance between one unit area (character area) and another unit area (character area) is equal to or less than a predetermined threshold value;

FIG. 24B illustrates a state of merging in a case where a distance between one unit area (character string area) and another unit area (character string area) is equal to or less than a predetermined threshold value;

FIG. 25 is a block diagram illustrating a configuration of a document processing device in a sixth embodiment; and

FIG. 26 illustrates an example of an application form.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

A search system 1 as a first embodiment according to the present disclosure will be described with reference to the drawings.

### 1.1 Search System 1

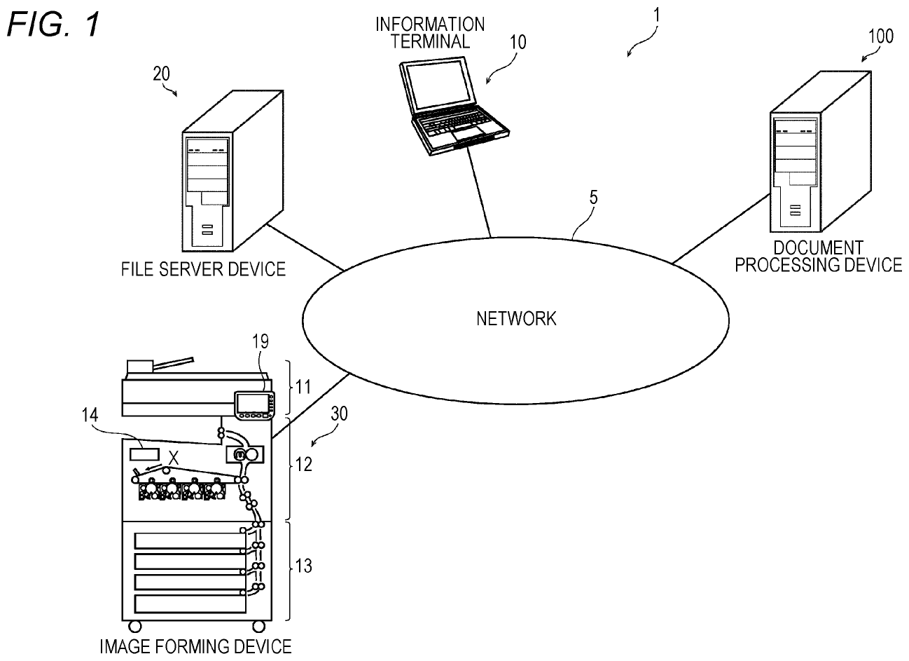

As illustrated in FIG. 1, the search system 1 includes a document processing device 100, an information terminal 10, a file server device 20, and an image forming device 30.

The document processing device 100, the information terminal 10, the file server device 20, and the image forming device 30 are connected to each other via a network 5.

The document processing device 100 receives document data including a plurality of pieces of page data from the file server device 20 via the network 5. In addition, the document processing device 100 may receive document data (document data obtained by scanning) including a plurality of pieces of page data from the image forming device 30 via the network 5.

The document processing device 100 extracts, from the received document data, a common object existing at a corresponding position over page data of a predetermined number of pages (a predetermined number of pieces) or more, and removes the common object from each of the plurality of pieces of page data when the common object is extracted. The document processing device 100 may assign a search tag to each piece of page data of the document data from which the common object has been removed. The document processing device 100 removes the common object, and transmits document data to which the search tag is assigned, to the file server device 20 via the network 5.

The file server device 20 receives the document data from which the common object is removed and to which the search tag is assigned, and internally stores the document data.

The information terminal 10 receives an input of a search condition for searching document data from the user. The information terminal 10 transmits the search condition whose input is received, to the file server device 20 via the network 5.

The file server device 20 searches for document data matching the search condition received from the information terminal 10, from a plurality of pieces of document data including the document data from which the common object is removed and to which the search tag is assigned. When document data matching the search condition exists, the file server device 20 transmits the document data to the information terminal 10 via the network 5.

The information terminal 10 receives the document data matching the search condition, from the file server device 20. Next, the information terminal 10 displays contents of the received document data.

### 1.2 Document Processing Device 100

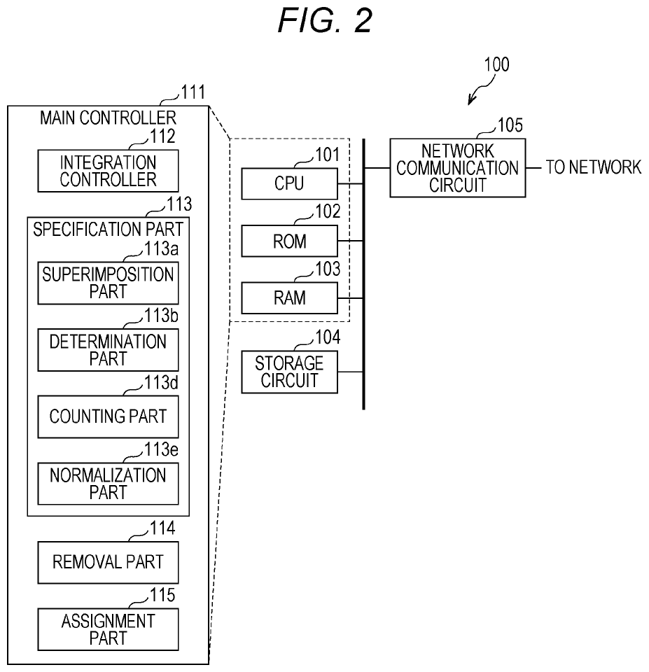

As illustrated in FIG. 2, the document processing device 100 includes a central processing unit (CPU) 101, a read only memory (ROM) 102, a random access memory (RAM) 103, a storage circuit 104, a network communication circuit 105, and the like.

The CPU 101, the ROM 102, and the RAM 103 constitute a main controller 111.

The RAM 103 temporarily stores various control variables and the like, and provides a work area when the CPU 101 executes a program.

The ROM 102 stores a control program (computer program) and the like to be executed in the document processing device 100.

The CPU 101 operates in accordance with the control program stored in the ROM 102.

By the CPU 101 operating in accordance with the control program, the main controller 111 integrally controls the storage circuit 104, the network communication circuit 105, and the like.

As described above, the document processing device 100 is a computer system including a microprocessor and a memory. The memory stores a computer program, and the microprocessor operates in accordance with the computer program. Here, the computer program is formed by combining a plurality of instruction codes indicating instructions to the computer in order to achieve a predetermined function.

By the CPU 101 operating in accordance with the control program stored in the ROM 102, the main controller 111 configures an integration controller 112, a specification part 113, a removal part 114, and an assignment part 115. The specification part 113 configures a superimposition part 113a, a determination part 113b, a counting part 113d, and a normalization part 113e.

The integration controller 112, the specification part 113, the removal part 114, the assignment part 115, the superimposition part 113a, the determination part 113b, the counting part 113d, and the normalization part 113e will be described later.

The network communication circuit 105 (acquisition unit) is connected to the network 5. The network communication circuit 105 acquires document data by receiving from an external device connected to the network 5, for example, the file server device 20 or the image forming device 30, and writes the acquired document data into the storage circuit 104 under the control of the main controller 111. The document data to be received includes a plurality of pieces of page data. Further, the network communication circuit 105 reads document data from the storage circuit 104 under the control of the main controller 111, and transmits the read document data to an external device connected to the network 5, for example, the file server device 20.

The storage circuit 104 includes, for example, a nonvolatile semiconductor memory. Note that the storage circuit 104 may include a hard disk unit. As an example, the storage circuit 104 stores document data received from the file server device 20 or the image forming device 30.

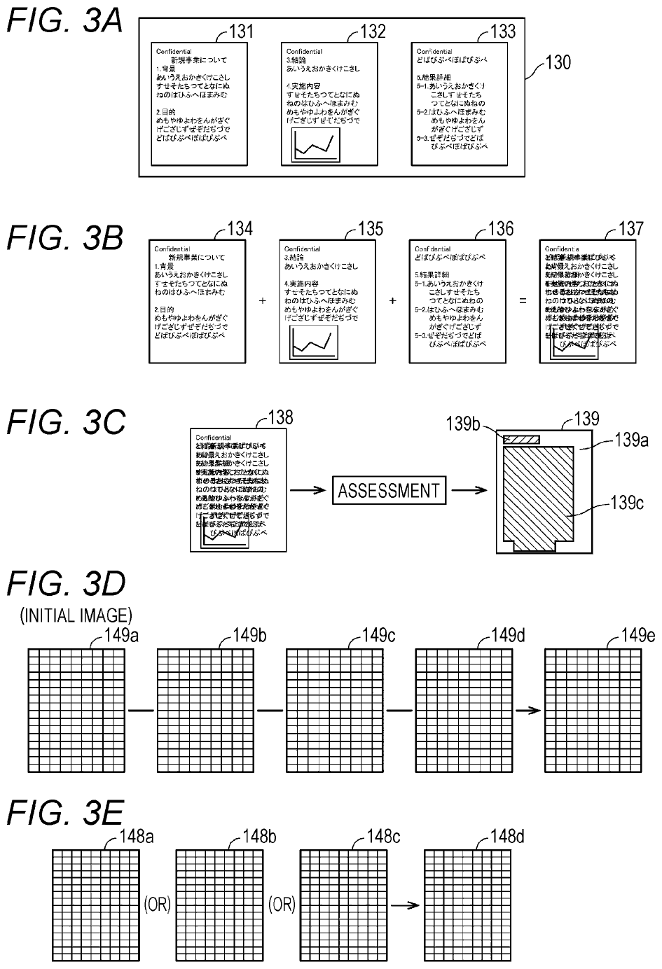

As an example, as illustrated in FIG. 3A, document data 130 stored in the storage circuit 104 includes page data 131 to 133. Each piece of page data is an image formed by arranging a plurality of pixels. At the same position in an upper part of these pieces of page data, the same character string “Confidential” is arranged. Contents of each piece of page data are different except for the portion of the character string “Confidential” arranged in the upper part of each page.

### 1.3 Main Controller 111

As described above, by the CPU 101 operating in accordance with the control program stored in the ROM 102, the main controller 111 configures the integration controller 112, the specification part 113, the removal part 114, and the assignment part 115.

### (1) Integration Controller 112

The integration controller 112 integrally controls the network communication circuit 105, the storage circuit 104, the specification part 113, the removal part 114, and the assignment part 115.

### (2) Specification Part 113

The specification part 113 (specification unit) specifies a common object existing at a corresponding position over page data of a predetermined number of pages or more, from the document data received from the file server device 20 or the image forming device 30.

As illustrated in FIG. 2, the specification part 113 includes the superimposition part 113a, the determination part 113b, the counting part 113d, and the normalization part 113e. Next, the superimposition part 113a, the determination part 113b, the counting part 113d, and the normalization part 113e will be described.

### (a) Superimposition Part 113a

The superimposition part 113a (superimposition unit) generates a superimposed image by superimposing a plurality of pieces of page data included in the document data for each corresponding pixel.

An example of a case where the superimposition part 113a generates a superimposed image by superimposing a plurality of pieces of page data for each corresponding pixel will be described with reference to FIG. 3B.

In this figure, page data 134, 135, and 136 correspond to the page data 131, 132, and 133 illustrated in FIG. 3A, respectively.

The superimposition part 113a generates a superimposed image 137 by superimposing three pieces of the page data 134, 135, and 136 for each corresponding pixel. In an upper part of the three pieces of the page data 134, 135, and 136, the same character string “Confidential” is arranged at the same position of each piece of page data. Contents of the page data images 134, 135, and 136 are different from each other except for the character string “Confidential” arranged in the upper part of each piece of page data. Therefore, when the three pieces of the page data 134, 135, and 136 are superimposed, the same character string “Confidential” arranged at the same position can be clearly read as illustrated in the superimposed image 137. Whereas, since different contents of the page data 134, 135, and 136 overlap with each other in other portions except for the character string “Confidential”, it is difficult to read the contents of these overlapping portions. The present disclosure utilizes this characteristic.

### SPECIFIC EXAMPLE 1

The superimposition part 113a may binarize a gradation value of each pixel in a plurality of pieces of page data of document data, perform an OR operation on binarized gradation values of the pixels existing at the corresponding positions in the plurality of pieces of page data, and generate the obtained operation result as a superimposed image.

As illustrated in FIG. 3E, each of page data 148a, 148b, and 148c is an image obtained by binarizing a gradation value of each pixel in page data of document data. In FIG. 3E, the smallest rectangle corresponds to a pixel. The gradation value of each pixel included in the page data 148a, 148b, and 148c is “0” or “1”.

The superimposition part 113a performs an OR operation on binarized gradation values of the pixels existing at the corresponding positions in the binarized page data 148a, 148b, and 148c to generate a superimposed image 148d. Therefore, the gradation value of each pixel included in the superimposed image 148d is “0” or “1”.

### SPECIFIC EXAMPLE 2

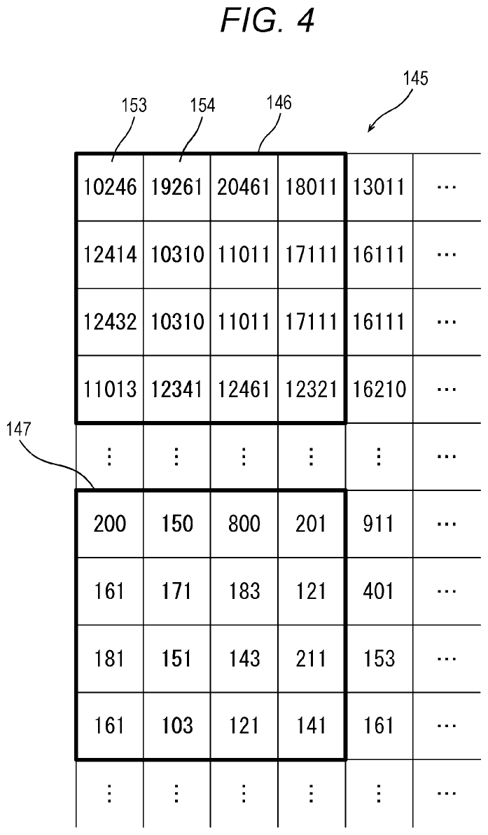

The superimposition part 113a may add all gradation values of pixels existing at corresponding positions in a plurality of pieces of page data of document data, to generate a superimposed image. FIG. 4 illustrates, as an example, a superimposed image 145 generated in this way. Here, as an example, the gradation value of each pixel of the plurality of pieces of page data of the document data is 0 to 255.

As illustrated in this figure, the superimposed image 145 is formed by arranging a plurality of pixels 153, 154, . . . in a matrix. The gradation value of each pixel is obtained by adding all gradation values of pixels existing at corresponding positions in a plurality of pieces of page data. Therefore, the gradation value of each pixel of the superimposed image 145 may take a value of 256 or more by the above addition.

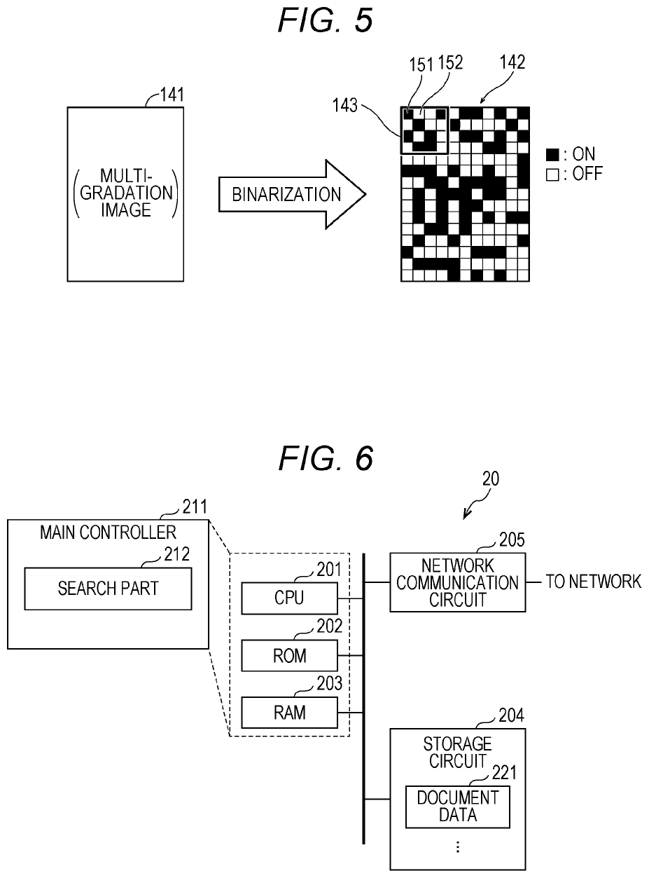

Next, the superimposition part 113a binarizes the gradation value of each pixel included in the superimposed image 145 (multi-gradation superimposed image 141 illustrated in FIG. 5), to generate a superimposed image 142 (FIG. 5) including the binarized gradation value.

Here, in the superimposed image 142 illustrated in FIG. 5, the smallest rectangle corresponds to a pixel.

### (b) Determination Part 113b

The determination part 113b (determination unit) refers a spatial density of a pixel having a gradation value in a predetermined range in the superimposed image generated by the superimposition part 113a, and determines a position where a common object exists in the superimposed image.

### SPECIFIC EXAMPLE

As described above, when the superimposed image is generated by the superimposition part 113a, the determination part 113b may count, for each unit area in the superimposed image, a number of ON pixels included in the unit area. In a case where there is a unit area whose count value is larger than a first threshold value and equal to or smaller than a second threshold value, the determination part 113b may determine a position where the unit area exists as a position where the common object exists.

Here, each of the plurality of pieces of page data includes a plurality of unit areas. Further, as an example, each unit area is formed by arranging eight pixels vertically and eight pixels horizontally in a total of 64 pixels in a matrix. Note that the unit area is not limited to this. As an example, the unit area may be formed by arranging four pixels vertically and four pixels horizontally in a total of 16 pixels in a matrix. Furthermore, as an example, the unit area may be formed by arranging eight pixels vertically and 16 pixels horizontally in a total of 128 pixels in a matrix.

### (c) Counting Part 113d

The counting part 113d (counting unit) may count a number of pages (number of pieces) of page data included in document data. The counting part 113d outputs the number of pages obtained by the counting, to the normalization part 113e.

### (d) Normalization Part 113e

The normalization part 113e receives the number of pages of page data included in the document data, from the counting part 113d.

The normalization part 113e (normalization unit) may calculate a normalized gradation value by normalizing, for each pixel in the plurality of pieces of page data of the document data, a gradation value of the pixel in accordance with the counted number of pages.

Specifically, the normalization part 113e may calculate the normalized gradation value by dividing a gradation value of each pixel in the plurality of pieces of page data in accordance with the number of pages.

The normalization part 113e may output the calculated normalized gradation value to the superimposition part 113a.

The superimposition part 113a receives the normalized gradation value for each pixel in the plurality of pieces of page data. The superimposition part 113a may use the received normalized gradation value for each pixel in the plurality of pieces of page data, to generate a superimposed image.

### (3) Removal Part 114

When a common object is specified by the specification part 113, the removal part 114 (removal unit) removes the specified common object from each of a plurality of pieces of page data of document data.

Specifically, in each of the plurality of pieces of page data of the document data, the removal part 114 replaces, with a blank, an area in which the common object is arranged.

### (4) Assignment Part 115

The assignment part 115 extracts, for each piece of page data of document data, an area in which a sentence is arranged, an area in which a figure is arranged, an area in which a graph is arranged, and an area in which a photograph is arranged. Next, type information indicating each area, that is, type information indicating which of a sentence, a figure, a graph, and a photograph is arranged in the area, and position information indicating a position of the area in the page data are written into the document data in association with each area. Here, the type information and the position information are referred to as a tag.

### 1.4 File Server Device 20

As illustrated in FIG. 6, the file server device 20 includes a CPU 201, a ROM 202, a RAM 203, a storage circuit 204, a network communication circuit 205, and the like.

The CPU 201, the ROM 202, and the RAM 203 constitute a main controller 211.

The RAM 203 temporarily stores various control variables and the like, and provides a work area when the CPU 201 executes a program.

The ROM 202 stores a control program (computer program) and the like to be executed in the file server device 20.

The CPU 201 operates in accordance with the control program stored in the ROM 202.

By the CPU 201 operating in accordance with the control program, the main controller 211 integrally controls the storage circuit 204, the network communication circuit 205, and the like.

As described above, the file server device 20 is a computer system including a microprocessor and a memory similar to those of the document processing device 100.

By the CPU 201 operating in accordance with the control program stored in the ROM 202, the main controller 211 configures a search part 212.

The network communication circuit 205 is connected to the network 5.

The network communication circuit 205 transmits document data to an external device connected to the network 5, for example, the document processing device 100. Furthermore, the network communication circuit 205 receives processed document data from an external device connected to the network 5, for example, the document processing device 100. The network communication circuit 205 writes the received document data into the storage circuit 204 under the control of the main controller 211. The document data to be transmitted and the document data to be received include a plurality of pieces of page data.

Furthermore, the network communication circuit 205 receives a search condition from an external device connected to the network 5, for example, the information terminal 10. The network communication circuit 205 outputs the received search condition to the search part 212.

Furthermore, the network communication circuit 205 receives designation (for example, a file name for identifying document data) of the document data of a search result, from the search part 212. The network communication circuit 205 reads the designated document data from the storage circuit 204, and transmits the read document data to the information terminal 10 via the network 5.

The storage circuit 204 includes, for example, a nonvolatile semiconductor memory. Note that the storage circuit 204 may include a hard disk unit. The storage circuit 204 stores a plurality of pieces of document data in advance. Each piece of document data includes a plurality of pieces of page data.

As an example, as illustrated in FIG. 3A, document data 130 stored in the storage circuit 204 includes page data 131 to 133.

The search part 212 receives the search condition from the information terminal 10, via the network 5 and the network communication circuit 205. The search part 212 searches the storage circuit 204 for document data that matches the received search condition. When document data matching the received search condition is found in the storage circuit 204, the search part 212 instructs the network communication circuit 205 to transmit the found document data to the information terminal 10.

As described above, the file server device 20 (search device) includes: the network communication circuit 205 (reception unit) that receives, from the document processing device 100, document data from which a common object has been removed from each of a plurality of pieces of page data, and receives a search condition for searching for document data from an information terminal 10 of a user; and the search part 212 (search unit) that searches for document data matching the received search condition from a plurality of pieces of document data including the received document data. Further, the network communication circuit 205 (transmission unit) transmits a search result obtained by the search part 212 to the information terminal 10.

### 1.5 Image Forming Device 30

The image forming device 30 is a tandem color multifunction peripheral (MFP) having functions of a scanner, a printer, and a copier.

As illustrated in FIG. 1, the image forming device 30 is provided with a sheet feeder 13 that accommodates and feeds a sheet, in a lower portion of a housing. Above the sheet feeder 13, a print engine 12 that forms an image by an electrophotographic method is provided. Further, above the print engine 12, there are provided: a scanner 11 that reads a document surface and generates image data; and an operation panel 19 that displays an operation screen and receives an input operation from a user.

The image forming device 30 is connected to the network 5.

The scanner 11 includes an automatic document conveying device. The automatic document conveying device conveys documents set in a document tray one by one to a document glass plate. The scanner 11 scans, with movement of the scanner, an image of the document conveyed to a predetermined position on the document glass plate by the automatic document conveying device, and obtains image data including multi-value digital signals of red (R), green (G), and blue (B). The scanner 11 writes the obtained image data into an image memory. In addition, by a user's operation, a plurality of pieces of image data obtained by the scanner 11 are transmitted as one piece of document data to the document processing device 100 via the network 5.

The image data of each color component obtained by the scanner 11 is subjected to various data processing in a control circuit 14, and is further converted into image data of each reproduction color of yellow (Y), magenta (M), cyan (C), and black (K).

The print engine 12 includes: an intermediate transfer belt; a driving roller that stretches the intermediate transfer belt; a driven roller; a backup roller; a plurality of image forming parts arranged at predetermined intervals along a traveling direction X of the intermediate transfer belt so as to face the intermediate transfer belt; a fixing part; and the like.

Each of the image forming parts includes a photosensitive drum that is an image carrier, an LED array to expose and scan a surface of the photosensitive drum, a charging charger, a developing device, a cleaner, a primary transfer roller, and the like.

The sheet feeder 13 includes: a plurality of sheet feeding cassettes that accommodate sheets having different sizes, and a pickup roller to deliver the sheet from each of the sheet feed cassettes to a conveyance path; and a manual sheet feeding tray on which the sheet is placed, and a pickup roller to deliver the sheet from the manual sheet feeding tray to the conveyance path.

In each of the image forming part, each photosensitive drum is uniformly charged by the charging charger and exposed by the LED array to form an electrostatic latent image on the surface of the photosensitive drum. Each electrostatic latent image is developed by the developing device of each color, toner images of Y to K colors are formed on the surface of each photosensitive drum, and the toner images are sequentially transferred onto a surface of the intermediate transfer belt by electrostatic action of each primary transfer roller disposed on a back surface side of the intermediate transfer belt.

Whereas, a sheet is fed from one of the sheet feeding cassettes of the sheet feeder 13 in accordance with an image forming operation by each image forming part, and conveyed on the conveyance path to a secondary transfer position where a secondary transfer roller and a backup roller face each other with the intermediate transfer belt interposed in between. At the secondary transfer position, the toner images of Y to K colors on the intermediate transfer belt are secondarily transferred to the sheet by an electrostatic action of the secondary transfer roller. The sheet on which the toner images of Y to K colors have been secondarily transferred is further conveyed to the fixing part.

The toner image on the surface of the sheet is fused and fixed to the surface of the sheet by heating and pressurization when passing through a fixing nip formed between a heating roller of the fixing part and a pressure roller pressed against the heating roller. The sheet is delivered to a discharge tray after passing through the fixing part.

The operation panel 19 is provided with a display surface including a liquid crystal display plate or the like, and displays contents set by the user and various messages.

### 1.6 Operation of Search System 1

An operation in the search system 1 will be described with reference to a flowchart.

### (1) Processing Procedure of Document Data

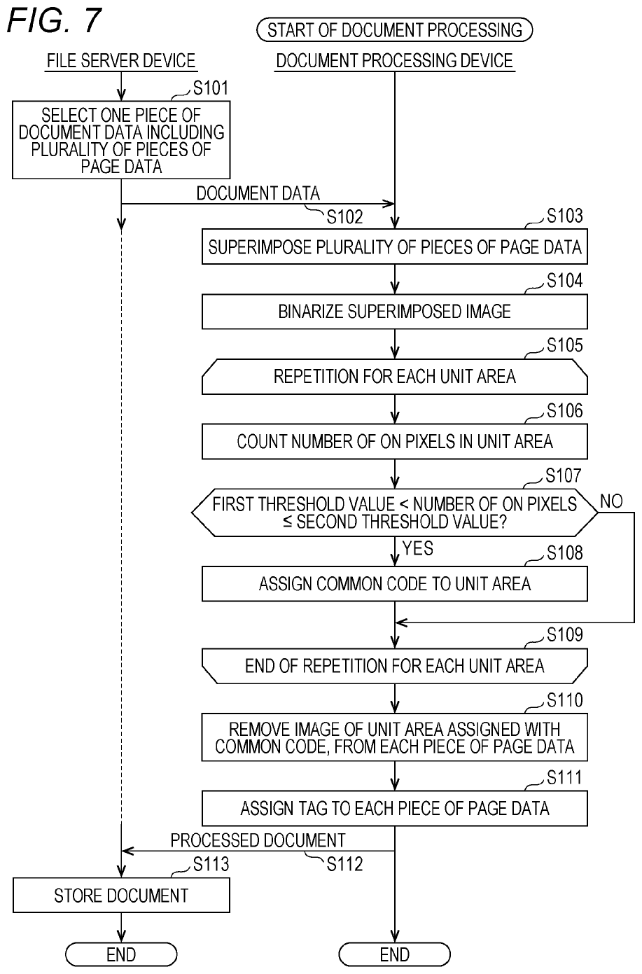

A processing procedure of document data will be described with reference to a flowchart illustrated in FIG. 7.

The main controller 211 of the file server device 20 selects one piece of document data including a plurality of pieces of page data, from a plurality of pieces of document data stored in the storage circuit 204 (step S101).

The network communication circuit 205 transmits the selected document data to the document processing device 100 via the network 5. The network communication circuit 105 receives the document data and writes the received document data into the storage circuit 104 (step S102).

The superimposition part 113a generates a superimposed image by superimposing a plurality of pieces of page data of the document data received and written in the storage circuit 104 (step S103). The superimposition part 113a binarizes gradation values of all pixels of the superimposed image (step S104).

The integration controller 112 repeats the following steps S106 to S108 for all the unit areas in the superimposed image (steps S105 to S109).

The determination part 113b counts a number of ON pixels in the unit area (step S106). Next, the determination part 113b judges whether or not the number of ON pixels is larger than a first threshold value and equal to or smaller than a second threshold value (step S107). When judging that the number of ON pixels is larger than the first threshold value and equal to or smaller than the second threshold value (“Yes” in step S107), the determination part 113b assigns a common code indicating a common object to the unit area (step S108).

When the repetition of steps S106 to S108 is ended (step S109), the removal part 114 removes an image portion of the unit area assigned with the common code, from each piece of page data (step S110).

Next, the assignment part 115 assigns a tag to each piece of page data (step S111).

Next, the network communication circuit 105 transmits the processed document data to the file server device 20 via the network 5. The network communication circuit 205 receives the document data (step S112). The network communication circuit 205 stores the received document data into the storage circuit 204 (step S113).

This is the end of the description of the processing procedure of the document data.

### (2) Search Processing Procedure of Document Data

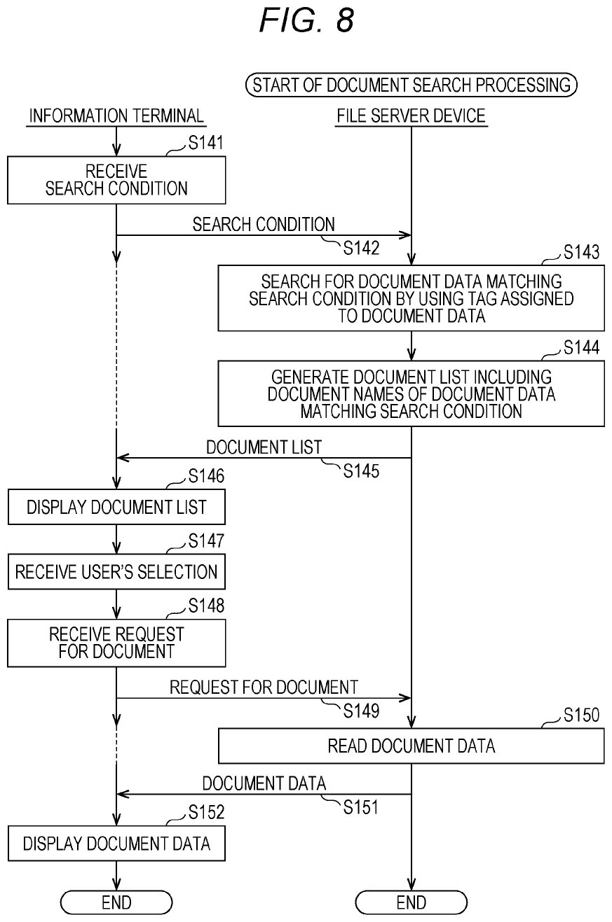

A search processing procedure of document data will be described with reference to a flowchart illustrated in FIG. 8.

The information terminal 10 receives a search condition from the user (step S141).

The information terminal 10 transmits the received search condition to the file server device 20. The network communication circuit 205 receives the search condition (step S142).

The search part 212 searches the storage circuit 204 for document data matching the received search condition, by using the tag assigned to the document data (step S143). The search part 212 generates a document list including document names of the document data matching the received search condition (step S144).

The network communication circuit 205 transmits the document list to the information terminal 10. The information terminal 10 receives the document list (step S145).

The information terminal 10 displays the document list (step S146), and receives selection of document data from the document list (step S147). Next, the information terminal 10 generates a request for the document data whose selection has been received (step S148), and the information terminal 10 transmits the generated request to the file server device 20. The network communication circuit 205 receives the request (step S149). The search part 212 reads the requested document data from the storage circuit 204 (step S150). The network communication circuit 205 transmits the read document data to the information terminal 10. The information terminal 10 receives the document data (step S151). The information terminal 10 displays the received document data (step S152).

This is the end of the description of the search processing procedure of the document data.

### 1.7 First Modification

The superimposition part 113a may add all gradation values of pixels existing at corresponding positions in a plurality of pieces of page data of document data, to generate an image obtained as an addition result as a superimposed image.

FIG. 4 illustrates, as an example, the superimposed image 145 generated in this way.

As illustrated in this figure, the superimposed image 145 is formed by arranging a plurality of pixels 153, 154, . . . in a matrix. A pixel gradation value of each pixel is obtained by adding all gradation values of pixels existing at corresponding positions in a plurality of pieces of page data.

In a case where there is a unit area including a gradation value equal to or larger than a threshold value in the superimposed image generated by the superimposition part 113a, the determination part 113b may determine a position where the unit area exists, as a position where the common object exists.

### (Processing Procedure of Document Data in First Modification)

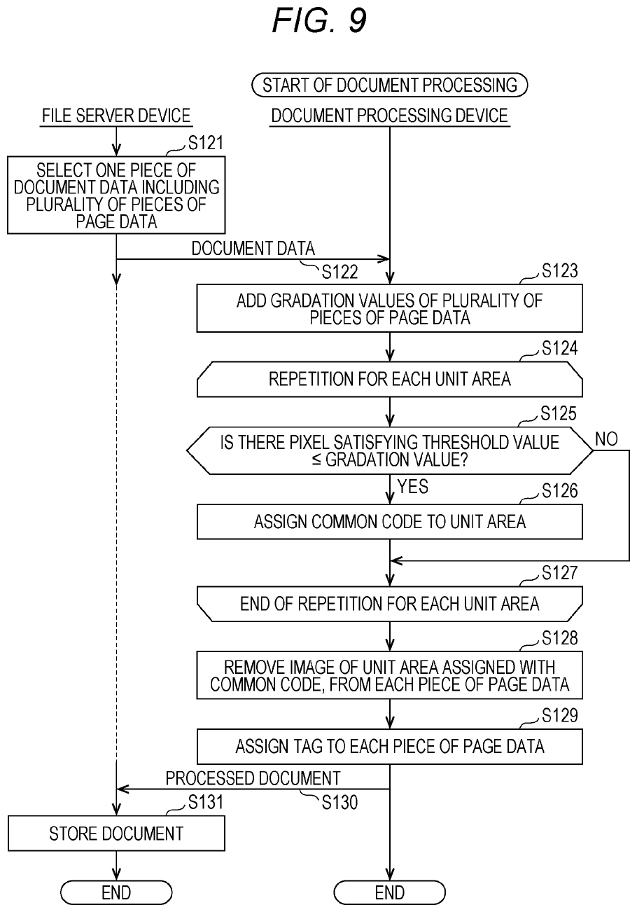

A processing procedure of document data in a first modification will be described with reference to a flowchart illustrated in FIG. 9.

The main controller 211 of the file server device 20 selects one piece of document data including a plurality of pieces of page data, from a plurality of pieces of document data stored in the storage circuit 204 (step S121).

The network communication circuit 205 transmits the selected document data to the document processing device 100 via the network 5. The network communication circuit 105 receives the document data and writes the received document data into the storage circuit 104 (step S122).

The superimposition part 113a adds gradation values of the plurality of pieces of page data of the document data received and written in the storage circuit 104, to generate a superimposed image (step S123).

The integration controller 112 repeats the following steps S125 and S126 for all the unit areas in the superimposed image (steps S124 to S127).

The determination part 113b judges whether or not there is a pixel satisfying threshold value <gradation value (step S125). When judging that there is a pixel satisfying threshold value <gradation value (“Yes” in step S125), the determination part 113b assigns a common code indicating a common object, to the unit area (step S126).

When the repetition of steps S125 and S126 is ended (step S127), the removal part 114 removes an image portion of the unit area assigned with the common code, from each piece of page data (step S128).

Next, the assignment part 115 assigns a tag to each piece of page data (step S129).

Next, the network communication circuit 105 transmits the processed document data to the file server device 20 via the network 5. The network communication circuit 205 receives the document data (step S130). The network communication circuit 205 stores the received document data into the storage circuit 204 (step S131).

This is the end of the description of the processing procedure of the document data in the first modification.

### 1.8 Second Modification

The superimposition part 113a may binarize a gradation value of each pixel in a plurality of pieces of page data of document data, and add all the binarized gradation values of pixels existing at corresponding positions in the plurality of pieces of page data, to generate an image obtained as an addition result as a superimposed image.

In a case where there is a unit area including a gradation value equal to or larger than a threshold value in the superimposed image generated by the superimposition part 113a, the determination part 113b may determine a position where the unit area exists, as a position where the common object exists.

### 1.9 Third Modification

The superimposition part 113a may generate an initial image including a pixel array with the same arrangement as pixels in a plurality of pieces of page data and having an initial value set to a gradation value of each pixel.

As illustrated in FIG. 3D, the superimposition part 113a may subtract all gradation values of pixels existing at corresponding positions in the plurality of pieces of page data 149b, 149c, 149d, . . . from a gradation value of a pixel existing at a corresponding position in an initial image 149a, and may generate an image obtained as a result of the subtraction as a superimposed image 149e.

In this figure, the smallest rectangle corresponds to a pixel.

Here, for example, it is assumed that “Confidential” exists at the upper left in each of the plurality of pieces of page data 149b, 149c, and 149d, gradation values of some of the corresponding pixels are “255”, and a gradation value of the corresponding pixel of the initial image is “0”.

For the corresponding pixel, the superimposition part 113a performs the following calculation to calculate, for example, a negative value “−765” as the gradation value of the corresponding pixel of the superimposed image.

0−255−255−255=−765

As described above, the superimposed image can also be generated by subtracting the gradation value, in addition to generating the superimposed image by adding the gradation value.

Here, the superimposition part 113a may set a value of 0 as an initial value of a gradation value of each pixel included in the initial image 149a. The superimposition part 113a may also binarize a gradation value of each pixel in the plurality of pieces of page data, and subtract all the binarized gradation values of pixels existing at corresponding positions in the plurality of pieces of page data from the initial image 149a, to generate a superimposed image.

As an example, an initial value “0” may be set to the gradation values of all the pixels included in the initial image 149a.

In a case where there is a unit area including a subtraction gradation value equal to or less than a threshold value in the superimposed image generated by the superimposition part 113a, the determination part 113b may determine a position where the unit area exists, as a position where the common object exists.

### 1.10 Fourth Modification

As described above, in a case of adding the gradation value or subtracting the gradation value, the superimposition part 113a may use a normalized gradation value generated by the normalization part 113e.

Since the normalization part 113e normalizes the gradation value for each pixel in the plurality of pieces of page data in accordance with the number of pages of the page included in the document data, the threshold value used in the determination part 113b is an appropriate value corresponding to the number of pages of the page data included in the document data.

### 1.11 Conclusion

As described above, according to the first embodiment, document data includes a plurality of pieces of page data, and the specification part 113 includes: the superimposition part 113a that generates a superimposed image by superimposing the plurality of pieces of page data for each corresponding pixel; and the determination part 113b that determines a position where a common object exists in the superimposed image by using a spatial density of a pixel having a gradation value in a predetermined range in the superimposed image.

This configuration makes it possible to specify and remove a portion unnecessary for search, from document data to be a search target.

### 2. Second Embodiment

A search system as a second embodiment according to the present disclosure will be described.

The search system of the second embodiment has a configuration similar to that of the search system 1 of the first embodiment. Here, differences from the first embodiment will be mainly described.

The search system of the second embodiment includes a document processing device 100a instead of the document processing device 100 of the first embodiment.

### 2.1 Document Processing Device 100a

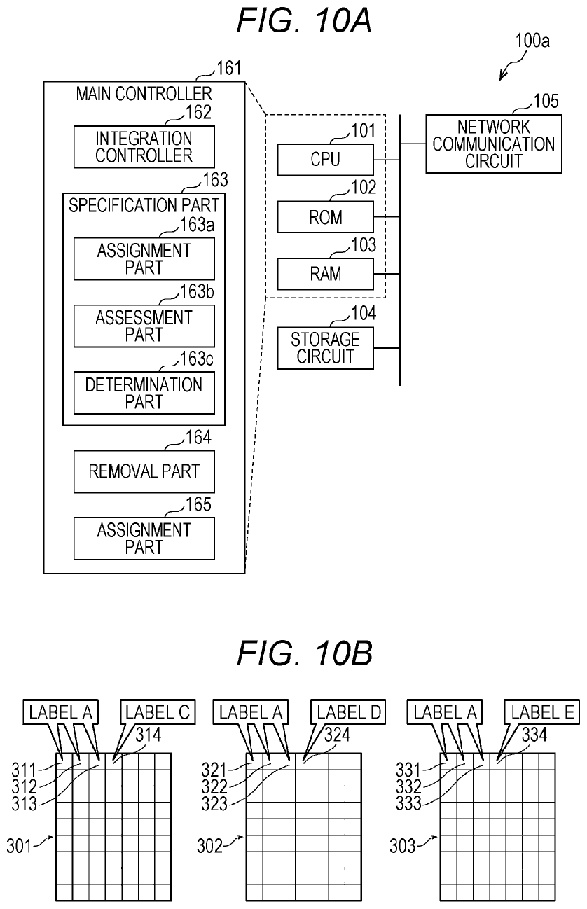

The document processing device 100a includes a main controller 161 as illustrated in FIG. 10A instead of the main controller 111 of the document processing device 100 of the first embodiment.

Similarly to the main controller 111 of the first embodiment, by a CPU 101 operating in accordance with a control program stored in a ROM 102, the main controller 161 configures an integration controller 162, a specification part 163, a removal part 164, and an assignment part 165. Note that the removal part 164 and the assignment part 165 have the same configurations as those of the removal part 114 and the assignment part 115 of the first embodiment, respectively, and thus description thereof is omitted.

### (1) Integration Controller 162

The integration controller 162 integrally controls a network communication circuit 105, a storage circuit 104, the specification part 163, the removal part 164, and the assignment part 165.

### (2) Specification Part 163

The specification part 163 specifies a common object existing at a corresponding position over page data of a predetermined number of pages or more, from document data received from a file server device 20 or an image forming device 30.

As illustrated in FIG. 10A, the specification part 163 includes an assignment part 163a, an assessment part 163b, and a determination part 163c. Next, the assignment part 163a, the assessment part 163b, and the determination part 163c will be described.

### (a) Assignment Part 163a

The assignment part 163a assigns, to each unit area in each piece of page data, a label characterizing the unit area.

FIG. 10B illustrates an example of a result of assigning the label by the assignment part 163a. In this figure, the smallest rectangle corresponds to a unit area.

As illustrated in this figure, “label A”, “label A”, “label A”, and “label C” are respectively assigned as labels to the unit areas 311, 312, 313, and 314 of page data 301. Further, “label A”, “label A”, “label A”, and “label D” are respectively assigned as labels to the unit areas 321, 322, 323, and 324 of page data 302. Further, “label A”, “label A”, “label A”, and “label E” are respectively assigned as labels to the unit areas 331, 332, 333, and 334 of page data 303.

In this manner, the same “label A” is assigned to each of the unit areas 311, 321, and 331 arranged at the same position in the page data 301 to 303. Further, the same “label A” is also assigned to each of the unit areas 312, 322, and 332 arranged at the same position in the page data 301 to 303. Moreover, the same “label A” is also assigned to each of the unit areas 313, 323, and 333 arranged at the same position in the page data 301 to 303.

Whereas, different labels are assigned to the unit areas 314, 324, and 334 arranged at the same position in the page data 301 to 303.

### (a-1) Example of Assigning ON Area Label and OFF Area Label

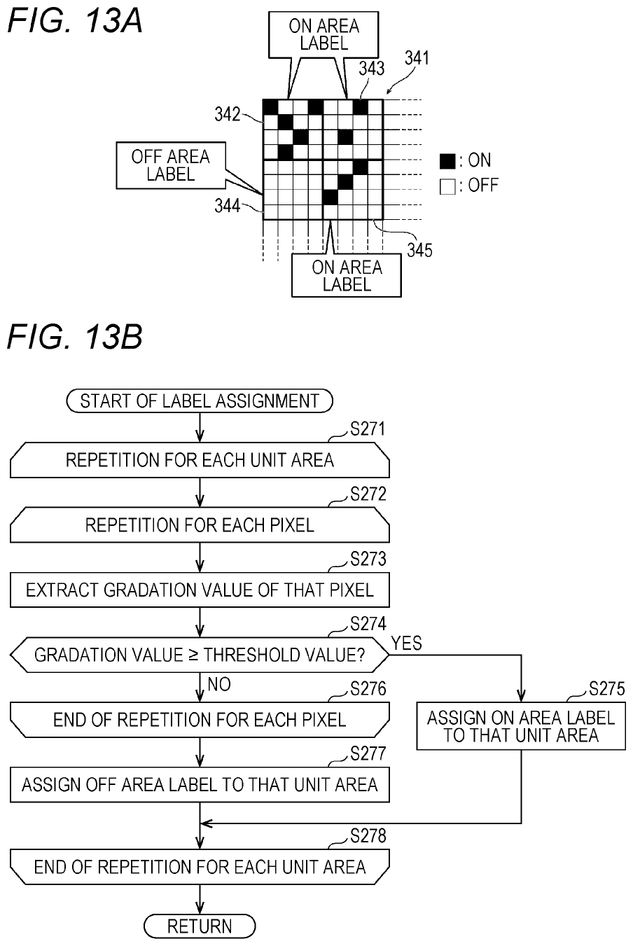

As described below, the assignment part 163a may assign an ON area label or an OFF area label to each unit area in each piece of page data of document data, as a label characterizing the unit area (see FIG. 13A).

The assignment part 163a repeats the following processes (i) and (ii) for each unit area in page data of each piece of page data of document data.

(i) For any one pixel in the unit area, the assignment part 163a extracts a gradation value of the pixel and judges whether the extracted gradation value is larger than or equal to a threshold value. When judging that the extracted gradation value is larger than or equal to the threshold value, the assignment part 163a assigns the ON area label to the unit area.

(ii) When judging that the extracted gradation value is smaller than the threshold value, that is, less than the threshold value for any pixel in the unit area, that is, for all pixels, the assignment part 163a assigns the OFF area label to the unit area.

As a result, one of the ON area label or the OFF area label is assigned to each unit area in each piece of page data of document data.

An example of the unit area to which one of the ON area label or the OFF area label is assigned in this manner is illustrated in FIG. 13A. Note that, in this figure, the smallest rectangle corresponds to a pixel, and rectangles denoted by reference numerals 342, 343, 344, and 345 each correspond to a unit area.

As illustrated in this figure, the ON area labels are assigned to the unit areas 342, 343, and 345. Whereas, the OFF area label is assigned to the unit area 344.

This is because, in the unit areas 342, 343, and 345, the extracted gradation value is larger than or equal to the threshold value for any one pixel in the unit area. Whereas, in the unit area 344, the extracted gradation value is smaller than the threshold value for any pixel in the unit area.

Note that the assignment part 163a may binarize the gradation value of each pixel for each unit area in each page of the document data, to generate a binary gradation value. The assignment part 163a may judge whether the binary gradation value is ON or OFF. Here, ON is larger than or equal to a threshold value “1”, and OFF is smaller than the threshold value “1”.

### (a-2) Example of Assigning Size of Circumscribed Rectangle

In a case where the ON area label is assigned to both a first unit area and a second unit area that are adjacent to each other after assignment of one of the ON area label or the OFF area label to each unit area in each piece of page data of the document data as described above, the assignment part 163a may merge the first unit area and the second unit area.

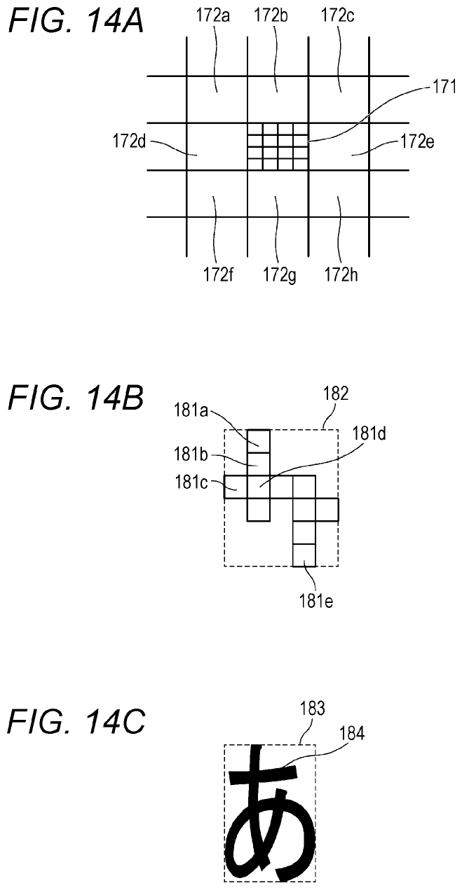

As illustrated in FIG. 14A, unit areas 172a, 172b, . . . , 172h adjacent to a unit area 171 exist around the unit area 171. Note that, here, as in the example between the unit area 171 and the unit area 172a, a case of being in contact with each other in an oblique direction is also included in being adjacent with each other.

In a case where the ON area label is assigned to both the unit area 171 and the unit area 172b, the assignment part 163a merges the unit area 171 and the unit area 172b. In this manner, the assignment part 163a merges a plurality of adjacent unit areas assigned with the same label for each piece of page data, into one enlarged area.

The assignment part 163a performs such merging of adjacent unit areas for the whole of each piece of page data of the document data. As a result, as illustrated in FIG. 14B or 14C, a plurality of unit areas are merged. In FIG. 14B, a plurality of unit areas 181a, 181b, . . . , 181e are merged. Furthermore, in FIG. 14C, an image 184 representing one character is formed by a plurality of unit areas that have been merged.

Next, the assignment part 163a generates a rectangle (hereinafter, referred to as a circumscribed rectangle) circumscribing the plurality of unit areas that have been merged, and acquires a size of the generated circumscribed rectangle (a length in a longitudinal direction and a length in a lateral direction). The assignment part 163a assigns the acquired size as a label to the circumscribed rectangular area.

In FIG. 14B, a circumscribed rectangle 182 circumscribing the plurality of unit areas 181a, 181b, . . . , 181e that have been merged is formed. A size of the circumscribed rectangle 182 is assigned to the area of the circumscribed rectangle 182.

Furthermore, in FIG. 14C, a circumscribed rectangle 183 circumscribing the image 184 of the character formed by the plurality of unit areas that have been merged is formed. A size of the circumscribed rectangle 183 is assigned to the area of the circumscribed rectangle 183.

Furthermore, as described above, each of the plurality of pieces of page data includes a plurality of unit areas, and a predetermined number of pixels are arranged in each unit area. The assignment part 163a may extract, for each unit area of each piece of page data, a feature in the unit area, and merge a plurality of unit areas to form one enlarged area in a case where the same feature exists in the plurality of adjacent unit areas. To the enlarged area, the assignment part 163a assigns one label indicating a common feature. The assessment part 163b assesses whether or not the same label is redundantly assigned to a corresponding enlarged area over a predetermined number of pieces or more of page data. The determination part 163c determines a position where the enlarged area exists as a position where a common object exists, by using a number of times that the assessment part 163b assesses that there is redundancy. The removal part 164 may remove the common object at the determined position.

Furthermore, as described above, each of the plurality of pieces of page data includes a plurality of unit areas, and a predetermined number of pixels are arranged in each unit area. The assignment part 163a judges, for each unit area in the plurality of pieces of page data, whether or not a gradation value of a pixel included in the unit area is equal to or larger than a predetermined threshold value. When the gradation value of at least one pixel is equal to or larger than the threshold value, the assignment part 163a sets the unit area as an ON pixel area. When another ON pixel area is adjacent to the unit area, the assignment part 163a merges the adjacent another ON pixel area to the unit area. The assignment part 163a generates a merged area (circumscribed rectangular area) including a circumscribed rectangle surrounding the merged area, and acquires a size of the generated merged area. The assignment part 163a assigns the acquired size to the merged area as a label characterizing the area. In this case, the assessment part 163b assesses whether or not the same label is redundantly assigned to the corresponding merged area over a predetermined number of pieces or more of page data. The determination part 163c determines a position where the merged area exists as a position where a common object exists, by using a number of times that the assessment part 163b assesses that there is redundancy. The removal part 164 removes the common object at the determined position.

### (a-3) Example of Assigning Label Indicating Color

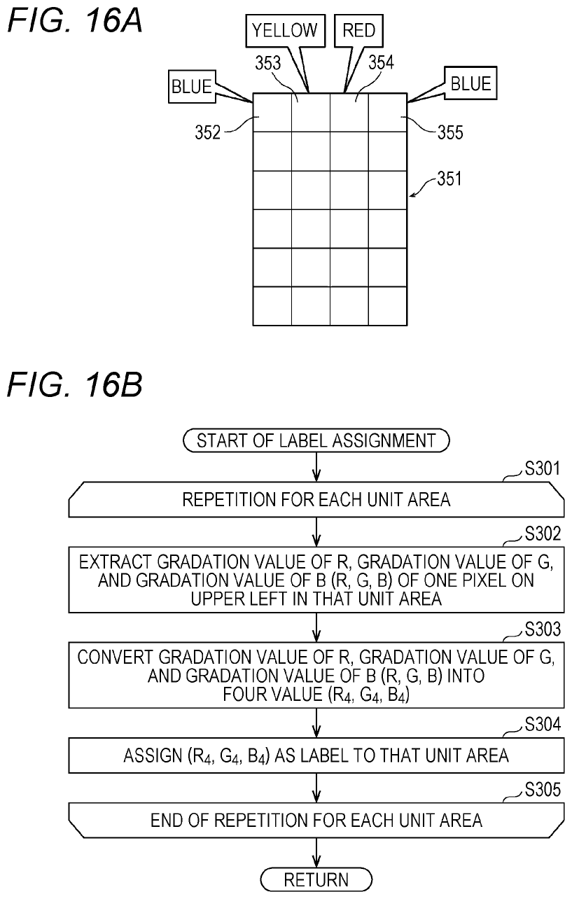

As described below, the assignment part 163a may assign a label indicating a color to each unit area in each piece of page data of document data, as a label characterizing the unit area (see FIG. 16A).

Here, each piece of page data of document data includes a color image in which a plurality of pixels are arranged. Specifically, it is assumed that pixels of multiple gradations (256 gradations) of R, G, and B are arranged in each piece of page data.

The assignment part 163a repeats the following process for each unit area in each piece of page data of document data.

For one pixel on the upper left in the unit area, the assignment part 163a extracts a gradation value of R, a gradation value of G, and a gradation value of B (R, G, B) of the pixel. Next, the assignment part 163a individually converts the gradation value of R, the gradation value of G, and the gradation value of B (R, G, B) into a four-value gradation value (R4, G4, B4). The assignment part 163a assigns the four-value gradation value (R4,G4, B4) as a label to the unit area. Here, the four-value gradation value (R4, G4, B4) is a representative color representing a color of the unit area.

In this manner, the assignment part 163a specifies the representative color representing colors of a plurality of pixels included in the unit area by using the gradation values of a plurality of pixels included in the unit area, and assigns the specified representative color as a label characterizing the unit area.

As an example, as illustrated in FIG. 16A, “blue”, “yellow”, “red”, and “blue” are respectively assigned as labels to the unit areas 352, 353, 354, and 355 of page data 351.

Note that the method of extracting the color from the unit area is not limited to the above.

The assignment part 163a may extract gradation values of all the pixels in the unit area, calculate an average value of all the extracted gradation values, and determine the representative color from the obtained average value.

### (b) Assessment Part 163b

The assessment part 163b assesses whether or not the same label is redundantly assigned to a corresponding unit area over page data of a predetermined number of pages (number of pieces) or more in document data.

Furthermore, the assessment part 163b may assess whether or not the same label is redundantly assigned to a corresponding circumscribed rectangular area (or enlarged area) over page data of a predetermined number of pages (number of pieces) or more.

In addition, the assessment part 163b may include a counter that is for counting a number of times that it is assessed that there is redundancy for each unit area. The assessment part 163b assesses whether or not there is redundancy between a label assigned to one unit area in first page data in document data and a label assigned to a corresponding unit area in another page data of the document data. The assessment part 163b may add a predetermined value (for example, “1”) to the counter of the unit area or subtract a predetermined value (for example, “1”) from the counter of the unit area every time assessing that there is redundancy.

### (c) Determination Part 163c

The determination part 163c may determine, in each piece of page data, a position where a unit area exists as a position where a common object exists, by using a number of times that the assessment part 163b assesses that there is redundancy.

Further, as described above, in a case where the assessment part 163b adds a predetermined value to the counter of the unit area, when the value of the counter in the unit area is equal to or larger than a predetermined threshold value, that is, when an absolute value of the value of the counter in the unit area is equal to or larger than the predetermined threshold value after the redundancy assessment for all labels is ended, the determination part 163c may determine a position where the unit area exists as a position where a common object exists. Note that, in this case, since the value of the counter takes a positive large value (for example, +1200), a case where the value of the counter is equal to or larger than the predetermined threshold value corresponds to a case where the absolute value of the value of the counter is equal to or larger than the predetermined threshold value.

Further, as described above, in a case where the assessment part 163b subtract a predetermined value from the counter of the unit area, when the value of the counter in the unit area is equal to or smaller than a predetermined threshold value, that is, when an absolute value of the value of the counter in the unit area is equal to or larger than the predetermined threshold value after the redundancy assessment for all labels is ended, the determination part 163c may specify a common object in the unit area. Note that, in this case, since the value of the counter takes a negative small value (for example, −1200), a case where the value of the counter is equal to or larger than a predetermined threshold value corresponds to a case where the absolute value of the value of the counter is equal to or smaller than the predetermined threshold value.

### 2.2 Operation in Search System of Second Embodiment

An operation in the search system according to the second embodiment will be described with reference to a flowchart.

### (1) Processing Procedure of Document Data

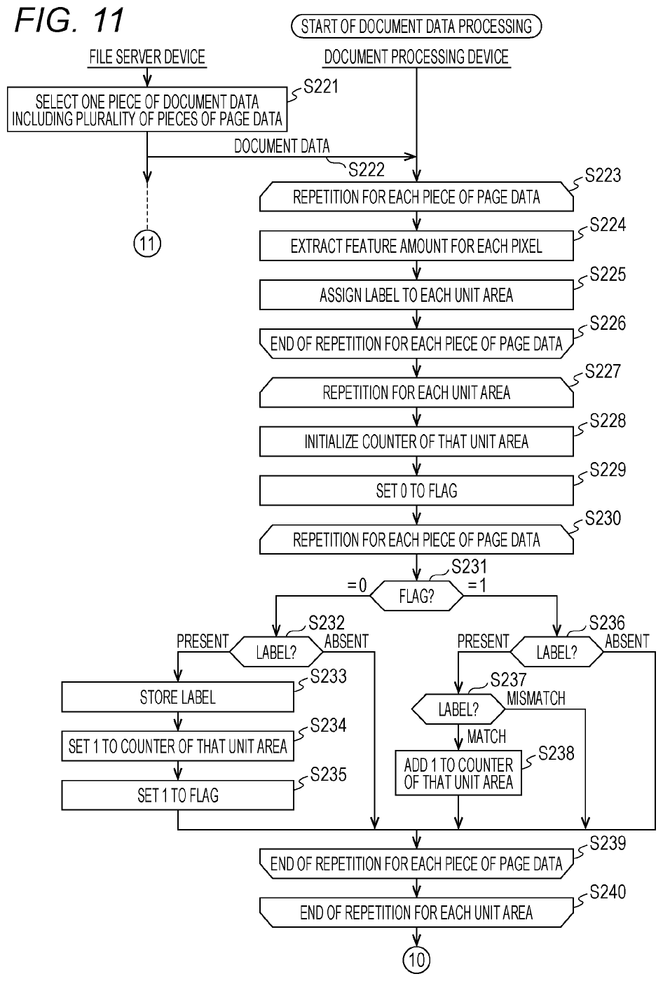

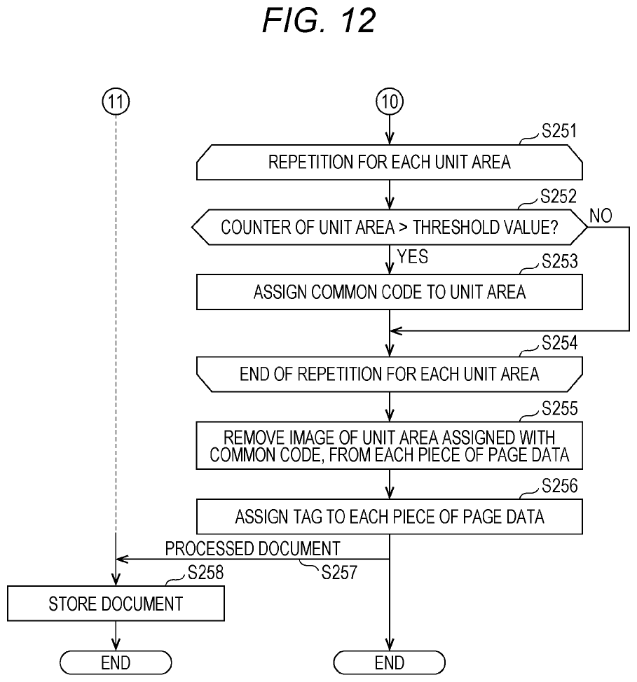

A processing procedure of document data will be described with reference to flowcharts illustrated in FIGS. 11 to 12.

A main controller 211 of the file server device 20 selects one piece of document data including a plurality of pieces of page data, from a plurality of pieces of document data stored in a storage circuit 204 (step S221).

A network communication circuit 205 transmits the selected document data to the document processing device 100a via a network 5. The network communication circuit 105 receives the document data and writes the received document data into the storage circuit 104 (step S222).

The integration controller 162 repeats the following steps S224 and S225 for each of a plurality of pieces of page data of the received document data (steps S223 to S226).

In step S224, the assignment part 163a extracts a feature amount for each pixel in page data constituting the page data. Next, in step S225, the assignment part 163a assigns a label to each unit area in the page data by using the feature amount extracted for each pixel.

When the repetition in steps S223 to S226 is ended, the integration controller 162 repeats the following steps S228 to S239 for each of the plurality of unit areas (steps S227 to S240).

In step S228, the integration controller 162 initializes the counter of the unit area. Specifically, an initial value “0” is set to the counter.

Next, in step S229, the integration controller 162 sets a flag to “0”.

Next, in steps S230 to S239, the integration controller 162 repeats the following steps S231 to S238 for each piece of page data.

The integration controller 162 judges whether the flag is “0” or “1” (step S231).

When judging that the flag is “0” (“=0” in step S231), the integration controller 162 judges whether or not a label is assigned to the unit area (step S232). When judging that a label is assigned to the unit area (“present” in step S232), the integration controller 162 stores the assigned label (step S233). Next, the integration controller 162 sets a value “1” to the counter of the unit area (step S234). Next, the integration controller 162 sets “1” to the flag (step S235).

When judging that no label is assigned to the unit area (“absent” in step S232), there is no processing by the integration controller 162.

When judging that the flag is “1” (“=1” in step S231), the integration controller 162 judges whether or not a label is assigned to the unit area (step S236). When judging that a label is assigned to the unit area (“present” in step S236), the integration controller 162 judges whether or not a stored label matches the assigned label (step S237). When judging that the stored label matches the assigned label (“match” in step S237), the integration controller 162 adds a value “1” to the counter of the unit area (step S238). When judging that the stored label does not match the assigned label (“mismatch” in step S237), there is no processing by the integration controller 162.

When the repetition for each piece of page data is ended (step S239) and the repetition for each unit area is ended (step S240), the integration controller 162 repeats steps S252 and S253 for each unit area (steps S251 to S254).

In step S252, the determination part 163c judges whether or not the value of the counter of the unit area is larger than a threshold value.

In step S253, when judging that the value of the counter of the unit area is larger than the threshold value (“Yes” in step S252), the determination part 163c assigns a common code to the unit area.

When judging that the value of the counter in the unit area is not larger than the threshold value (“No” in step S252), the determination part 163c does not assign a common code to the unit area.

When the repetition for each unit area is ended (step S254), the removal part 164 removes an image portion of the unit area assigned with the common code, from each piece of page data (step S255).

Next, the assignment part 165 assigns a tag to each piece of page data (step S256).

Next, the network communication circuit 105 transmits the processed document data to the file server device 20 via the network 5. The network communication circuit 205 receives document data (step S257), and the network communication circuit 205 stores the received document data into the storage circuit 204 (step S258).

This is the end of the description of the processing procedure of the document data.

### (2) Procedure for Assigning ON Area Label and OFF Area Label

A procedure for assigning the ON area label and the OFF area label will be described with reference to a flowchart illustrated in FIG. 13B.

The assignment part 163a repeats steps S272 to S277 for each unit area of page data in each piece of page data (steps S271 to S278).

In steps S272 to S276, the assignment part 163a repeats steps S273 and S274 for each pixel in the unit area.

In step S273, the assignment part 163a acquires a gradation value of the pixel.

In step S274, the assignment part 163a compares the gradation value of the pixel with a threshold value, and judges whether the gradation value is larger than or equal to a threshold value.

When judging that the gradation value is larger than or equal to the threshold value (“Yes” in step S274), the assignment part 163a assigns the ON area label to the unit area (step S275), and then ends the repetition for each pixel.

When judging that the gradation value is smaller than the threshold value (“No” in step S274), there is no processing by the assignment part 163a.

When the repetition for each pixel is ended (step S276), the assignment part 163a assigns the OFF area label to the unit area (step S277).

When the repetition for each unit area is ended (step S278), the operation of assigning the ON area label and the OFF area label is ended.

### (3) Procedure for Assigning Size of Circumscribed Rectangle

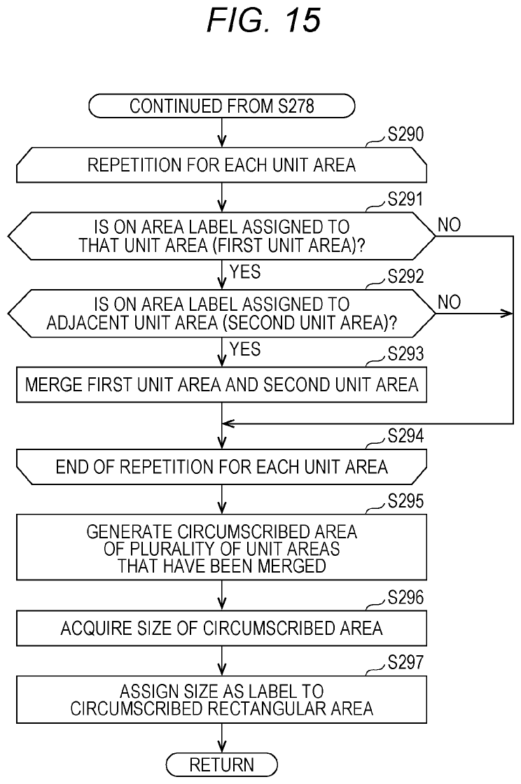

A procedure for assigning a size of a circumscribed rectangle will be described with reference to a flowchart illustrated in FIG. 15.

In the flowchart illustrated in FIG. 13B, when step S278 is ended, the assignment part 163a repeats the following steps S291 to S293 for each unit area in each piece of page data of document data (steps S290 to S294).

The assignment part 163a judges whether or not the ON area label is assigned to the unit area (referred to as a first unit area) (step S291).

When judging that the ON area label is assigned to the first unit area (“Yes” in step S291), the assignment part 163a judges whether or not the ON area label is assigned to a unit area (referred to as a second unit area) adjacent to the first unit area (step S292).

When judging that the ON area label is assigned to the second unit area (“Yes” in step S292), the assignment part 163a merges the first unit area and the second unit area (step S293).

When judging that the ON area label is not assigned to the first unit area (“No” in step S291), or when judging that the ON area label is not assigned to the second unit area (“No” in step S292), there is no processing by the assignment part 163a.

When the repetition for each unit area is ended (step S294), the assignment part 163a generates a circumscribed area (circumscribed rectangular area) of a circumscribed rectangle circumscribing the plurality of unit areas that have been merged (step S295). Next, the assignment part 163a acquires a size of the generated circumscribed area (step S296). Next, the assignment part 163a assigns the size as a label to the circumscribed rectangular area (step S297).

This is the end of the description of the operation of assigning the size of the circumscribed rectangle.

### (4) Procedure for Assigning Label Indicating Color

A procedure for assigning a label indicating a color will be described with reference to a flowchart illustrated in FIG. 16B.

The assignment part 163a repeats the following steps S302 to S304 for each unit area in page data of each piece of page data of document data (steps S301 to S305).

For one pixel on the upper left in the unit area, the assignment part 163a extracts a gradation value of R, a gradation value of G, and a gradation value of B (R, G, B) of the pixel (step S302).

Next, the assignment part 163a individually converts the gradation value of R, the gradation value of G, and the gradation value of B (R, G, B) into a four-value gradation value (R4, G4, B4) (step S303).

Next, the assignment part 163a assigns the four-value gradation value (R4, G4, B4) as a label to the unit area (step S304).

This is the end of the description of the operation of assigning a label indicating a color.

### 3. Third Embodiment

A search system as a third embodiment according to the present disclosure will be described.

The search system of the third embodiment has a configuration similar to that of the search system 1 of the first embodiment. Here, differences from the first embodiment will be mainly described.

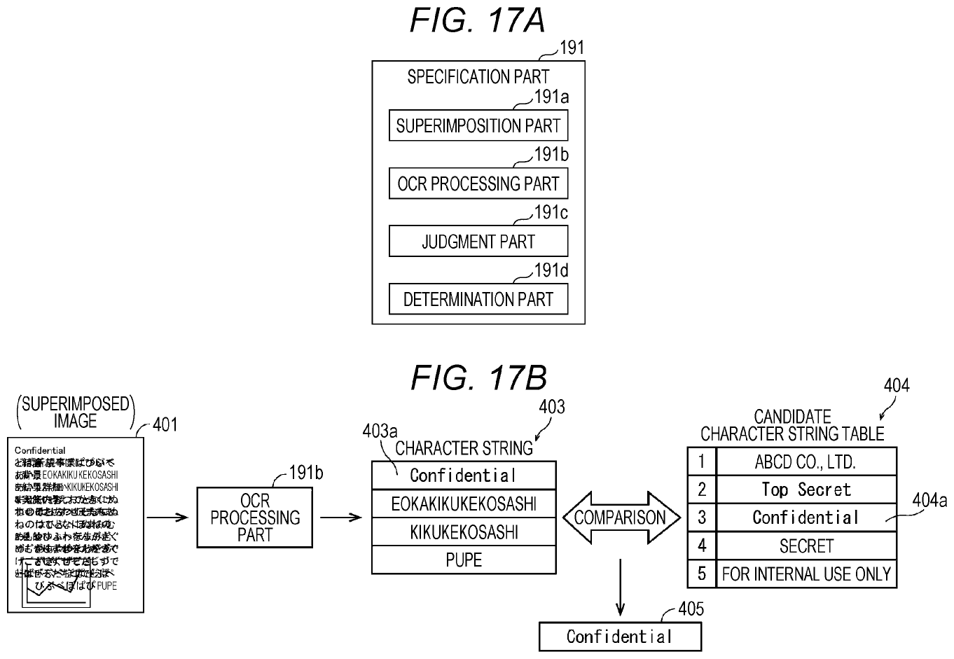

A document processing device 100 of the third embodiment includes a specification part 191 illustrated in FIG. 17A instead of the specification part 113 included in the document processing device 100 of the first embodiment. In addition, a storage circuit 104 of the document processing device 100 of the third embodiment stores in advance a candidate character string table 404 illustrated in FIG. 17B.

### 3.1 Candidate Character String Table 404

As illustrated in FIG. 17B, the candidate character string table 404 includes a plurality of candidate character strings. As illustrated in this figure, the candidate character string table 404 includes, as an example, candidate character strings “ABCD Co., Ltd.”, “Top Secret”, “Confidential”, “Secret”, and “For internal use only”.

As will be described later, these candidate character strings are compared with an extracted character string obtained by performing OCR processing on a superimposed image.

### 3.2 Specification Part 191

As illustrated in FIG. 17A, the specification part 191 includes a superimposition part 191a, an OCR processing part 191b, a judgment part 191c, and a determination part 191d.

### (a) Superimposition Part 191a

The superimposition part 11a generates a superimposed image by superimposing a plurality of pieces of page data included in document data for each corresponding pixel.

When superimposing the plurality of pieces of page data, the superimposition part 191a binarizes a gradation value of each pixel in the plurality of pieces of page data, and performs OR operation on binarized gradation values of pixels existing at corresponding positions in the plurality of pieces of page data, to generate the superimposed image.

Further, when superimposing the plurality of pieces of page data, the superimposition part 191a adds all the gradation values of the pixels existing at the corresponding positions in the plurality of pieces of page data, to generate an intermediate superimposed image including the added gradation value. Next, the gradation value of each pixel of the generated intermediate superimposed image is binarized to generate a superimposed image.

### (b) OCR Processing Part 191b

The OCR processing part 191b performs OCR processing on the superimposed image generated by the superimposition part 191a, and extracts a character string from the superimposed image.

In a case where the same character string is represented at the same position in the plurality of pieces of page data, the character string is also represented in the superimposed image.

For example, in a case where the same character string “Confidential” is represented at the same position in a plurality of pieces of page data, the character string “Confidential” is represented in a superimposed image 401 as illustrated in FIG. 17B. Therefore, the character string “Confidential” can be extracted from the superimposed image 401 by the OCR processing.

Whereas, in a case where different character strings are represented at the same position in a plurality of pieces of page data, since different character strings are overlapped in the superimposed image, the character string is not able to be extracted from that position of the superimposed image.

In the example illustrated in FIG. 17B, the OCR processing part 191b extracts a character string 403 including the character strings “Confidential”, “Eokakikukekosaslu”, “kikukekosasln”, and “Pupe”.

The OCR processing part 191b outputs the extracted character string to the judgment part 191c.

### (c) Judgment Part 191c

When a character string is extracted by the OCR processing part 191b, the judgment part 191c judges whether or not the extracted character string is a specific character string.

Specifically, the judgment part 191c judges whether or not the extracted character string is included in the candidate character string table 404.

In the example illustrated in FIG. 17B, the judgment part 191c judges that the same character string as the extracted character string “Confidential” is included in the candidate character string table 404.

The judgment part 191c outputs a judgment result and the character string included in the candidate character string table 404, to the determination part 191d.

### (d) Determination Part 191d

When the judgment part 191c judges that the extracted character string is a specific character string, the determination part 191d assigns a common code indicating a common object, to an image portion of the extracted and matched character string. As a result, a position where the extracted character string exists in the page data is determined as a position where a common object exists.

### 3.3 Processing Procedure of Document Data

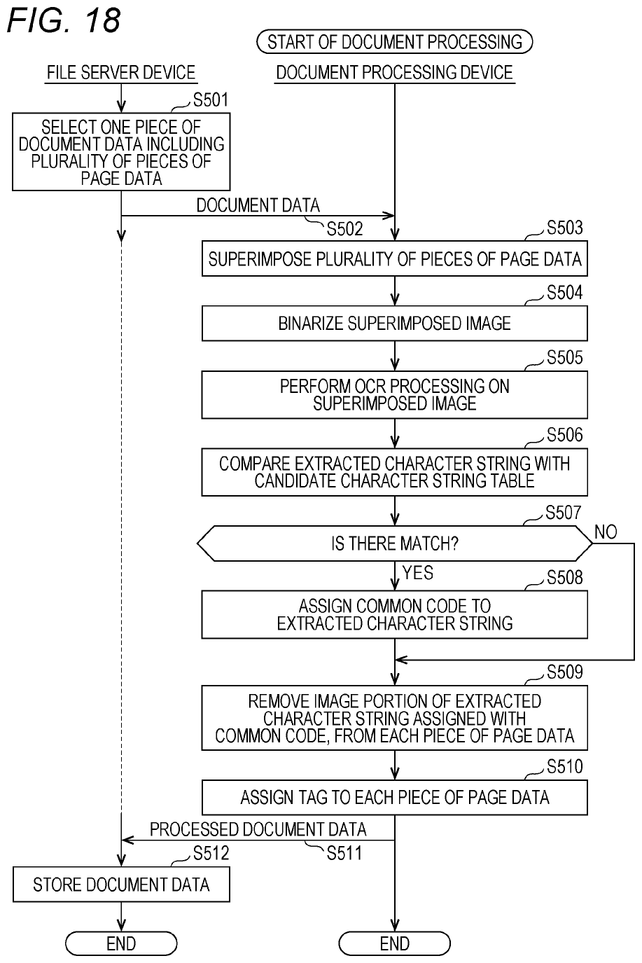

A processing procedure of document data in the third embodiment will be described with reference to a flowchart illustrated in FIG. 18.

A main controller 211 of a file server device 20 selects one piece of document data including a plurality of pieces of page data, from a plurality of pieces of document data stored in a storage circuit 204 (step S501).

A network communication circuit 205 transmits the selected document data to the document processing device 100 via a network 5. A network communication circuit 105 receives the document data and writes the received document data into the storage circuit 104 (step S502).

The superimposition part 191a generates a superimposed image by superimposing the plurality of pieces of page data of the document data received and written in the storage circuit 104 (step S503). The superimposition part 191a binarizes gradation values of all pixels of the superimposed image (step S504).

The OCR processing part 191b performs OCR processing on the superimposed image (step S505).

The judgment part 191c compares the extracted character string with the character string included in the candidate character string table 404 (step S506). When the extracted character string matches the character string included in the candidate character string table 404 (“Yes” in step S507), the determination part 191d assigns a common code indicating a common object, to an image portion of the extracted and matched character string (step S508).

A removal part 114 removes an image portion assigned with a common code, from each piece of page data (step S509).

Next, an assignment part 115 assigns a tag to each piece of page data (step S510).

Next, the network communication circuit 105 transmits the processed document data to the file server device 20 via the network 5. The network communication circuit 205 receives the document data (step S511). The network communication circuit 205 stores the received document data into the storage circuit 204 (step S512).

This is the end of the description of the processing procedure of the document data of the third embodiment.

### 3.4 Conclusion

As shown in FIG. 17B, among the character strings “Confidential”, “Eokakikukekosashi”, “Kikukekosashi”, and “Pupe” extracted by the OCR processing part 191b, the character strings “Eokakikukekosashi”, “Kikukekosashi”, and “Pupe” are character strings represented at specific positions of one piece alone of page data among a plurality of page images, and there is a high possibility that such character strings do not exist at corresponding specific positions on other page data. Such character strings should not be extracted as common objects.

According to the third embodiment, in a case where a character string is represented at a specific position of one piece alone of page data among a plurality of page images, and this character string does not exist at corresponding specific positions on other page data, it is possible to avoid judging such a character string as a common object displayed at the same position of the plurality of page images.

### 4. Fourth Embodiment

A search system as a fourth embodiment according to the present disclosure will be described.

The search system of the fourth embodiment has a configuration similar to that of the search system 1 of the first embodiment. Here, differences from the first embodiment will be mainly described.

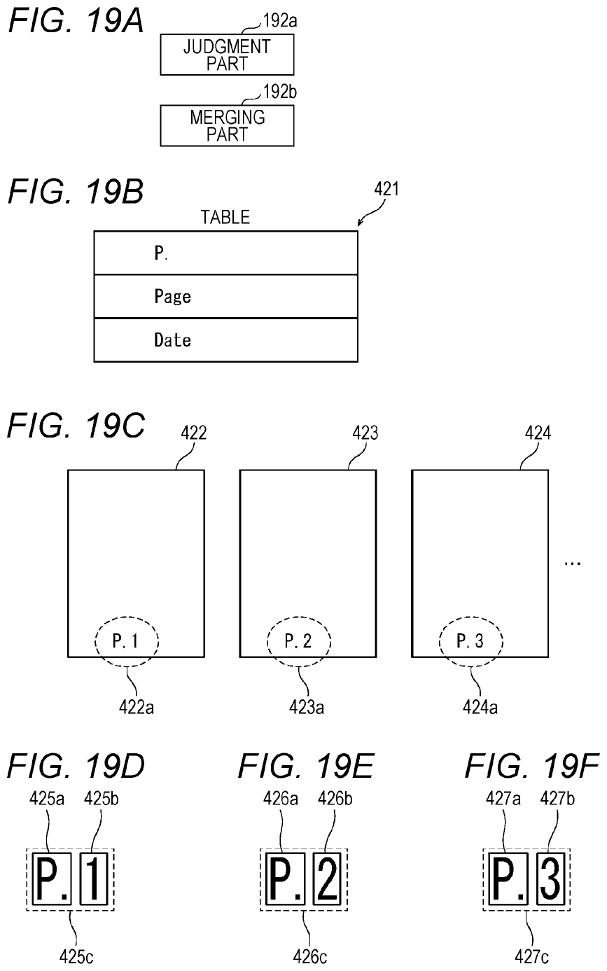

A specification part 113 included in a document processing device 100 of the fourth embodiment further includes a judgment part 192a and a merging part 192b illustrated in FIG. 19A. In addition, a storage circuit 104 of the document processing device 100 of the fourth embodiment stores in advance a special table 421 illustrated in FIG. 19B.

### 4.1 Special Table 421

As illustrated in FIG. 19B, the special table 421 includes a plurality of character strings. As illustrated in this figure, the special table 421 includes, as an example, character strings “P.”, “Page”, and “Date”. Note that the special table 421 may include “P.”, “Page”, and “Date” as figures. Furthermore, “P.”, “Page”, and “Date” may be included as images.

As will be described later, in a case where these character strings are detected as a common object in a superimposed image, an area existing within a predetermined distance from the common object is merged into the common object.

### 4.2 Judgment Part 192a

The judgment part 192a judges whether or not the common object has a specific shape.

Specifically, the judgment part 192a judges whether or not contents represented by the common object match any of the character strings included in the special table 421.

As illustrated in FIG. 19C, page data 422, 423, and 424 include page number displays 422a, 423a, and 424a indicating page numbers at respective lower portions.

The page number displays 422a, 423a, and 424a are “P.1”, “P.2”, and “P.3”, respectively, and indicate the first page, the second page, and the third page.

In the page number displays 422a, 423a, and 424a, “P.” is the same contents represented at the same position of the page data 422, 423, and 424. Therefore, as described in the first embodiment, “P.” is judged as the common object.

Here, “P.” matches one of the character strings included in the special table 421.

The judgment part 192a outputs the judgment result to the merging part 192b.

### 4.3 Merging Part 192b

When the judgment part 192a judges that a common object has a specific shape, the merging part 192b merges, in the page data, an object existing within a predetermined distance from the common object into the common object.

FIGS. 19D, 19E, and 19F correspond to the page number displays 422a, 423a, and 424a illustrated in FIG. 19C, respectively.

A page number display 425c illustrated in FIG. 19D includes a common object 425a and a non-common area 425b. The common object 425a is “P.” and is a sign (abbreviation) indicating a page number display. The non-common area 425b represents a page number in the page number display. Here, the common object 425a and the non-common area 425b exist within a predetermined distance.

Since the common object 425a and the non-common area 425b exist within a predetermined distance, the merging part 192b merges the common object 425a and the non-common area 425b into a new common object.

Page number displays 426c and 427c illustrated in FIGS. 19E and 19F are also similar to the page number display 425c. The merging part 192b merges a common object 426a and a non-common area 426b into a new common object. Furthermore, the merging part 192b merges a common object 427a and a non-common area 427b into a new common object.

### 4.4 Processing Procedure of Document Data

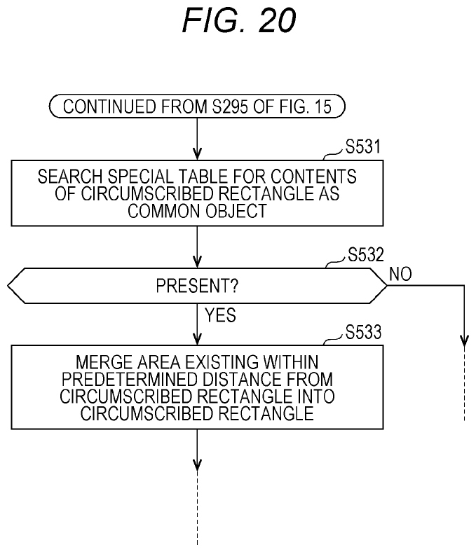

A processing procedure of document data in the fourth embodiment will be described with reference to a flowchart illustrated in FIG. 20.

The procedure described below is a continuation of step S295 of the flowchart illustrated in FIG. 15.

The judgment part 192a searches the special table 421 for contents of a circumscribed rectangle as the common object (step S531).

When the judgment part 192a judges that the contents of the circumscribed rectangle is present in the special table 421 (“Yes” in step S532), the merging part 192b merges, in the page data, an object existing in an area existing within a predetermined distance from the circumscribed rectangle that is the common object, into the circumscribed rectangle that is the common object (step S533).

This is the end of the description of the processing procedure of the document data in the fourth embodiment.

### 4.5 Conclusion

In a plurality of pieces of page data of document data, a code or a character string (“P.”, “Page”, “Date”, and the like) indicating that a subsequent number or the like is a page number or a date is often indicated. These code and character string are arranged at the same position in the plurality of pieces of page data. Therefore, these code and character string are judged as the common object as described in the first embodiment.

Whereas, since numbers and the like displayed following these code and character string are different in each page, they are not judged as the common object.

However, these code and character string, and a number and the like displayed subsequently are desirably handled as one unit, and are judged as common objects in the fourth embodiment. As a result, these code and character string, and the number and the like displayed subsequently are removed as one unit from the page data by the removal part 114.

### 5. Fifth Embodiment

A search system as a fifth embodiment according to the present disclosure will be described.

The search system of the fifth embodiment has a configuration similar to that of the search system 1 of the first embodiment. Here, differences from the first embodiment will be mainly described.

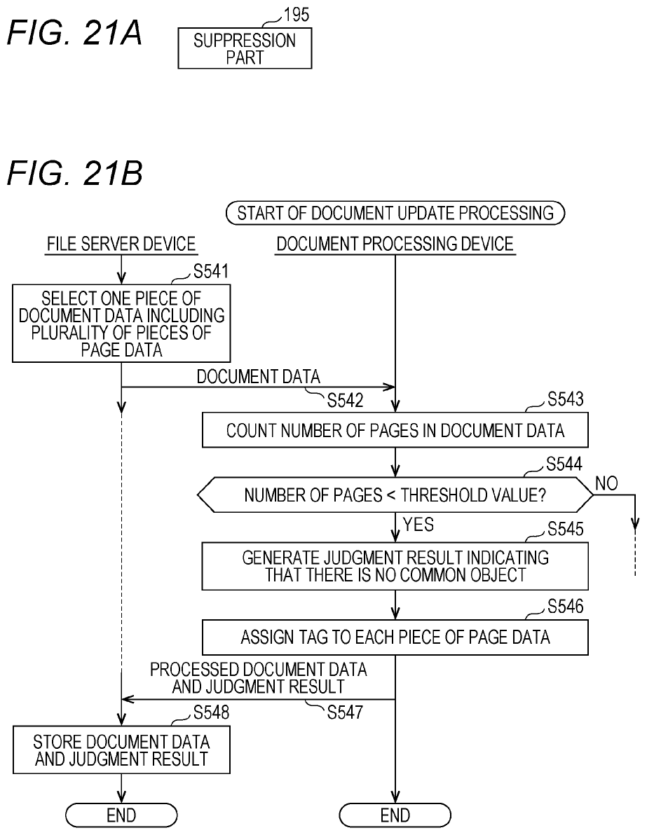

A main controller 111 included in a document processing device 100 of the fifth embodiment further includes a suppression part 195 illustrated in FIG. 21A.

When the number of pages of page data included in document data is less than a threshold value (a predetermined number of pages, or a predetermined number of pieces), the suppression part 195 suppresses specification of a common object by a specification part 113.

When the number of pages of the page data included in the document data is less than the threshold value, the suppression part 195 may output judgment information indicating that there is no common object.

Here, a network communication circuit 105 may transmit the judgment information to a file server device 20.

### 5.1 Processing Procedure of Document Data

A processing procedure of document data will be described with reference to flowcharts illustrated in FIGS. 21A and 21B.

A main controller 211 of the file server device 20 selects one piece of document data including a plurality of pieces of page data, from a plurality of pieces of document data stored in a storage circuit 204 (step S541).

A network communication circuit 205 transmits the selected document data to the document processing device 100 via a network 5. The network communication circuit 105 receives the document data and writes the received document data into a storage circuit 104 (step S542).

A counting part 113d counts a number of pages included in the document data received and written in the storage circuit 104 (step S543).

An integration controller 112 compares the counted number of pages with a threshold value, and judges whether or not the number of pages is less than the threshold value (step S544).

When judging that the number of pages is equal to or larger than the threshold value (“No” in step S544), the integration controller 112 shifts the control to step S103 of the flowchart illustrated in FIG. 7.

When judging that the number of pages is less than the threshold value (“Yes” in step S544), the suppression part 195 suppresses specification of a common object by the specification part 113 and generates a judgment result indicating that there is no common object (step S545).

Next, an assignment part 115 assigns a tag to each piece of page data (step S546).

Next, the network communication circuit 105 transmits the processed document data and the judgment result to the file server device 20 via the network 5. The network communication circuit 205 receives the document data and the judgment result (step S547), and the network communication circuit 205 stores the received document data and judgment result into the storage circuit 204 (step S548).

This is the end of the description of the processing procedure of the document data.

### 5.2 Conclusion

In the fifth embodiment, when the number of pages of the document data is less than the threshold value, specification of the common object from the plurality of pages is suppressed since there is a low possibility that a common object exists at the same position of the plurality of pages.

### 5.3 First Modification

Here, a first modification of the fifth embodiment will be described focusing on differences from the fifth embodiment.

The storage circuit 104 stores another document data (second document data) including a plurality of pieces of page data.

### (Processing Procedure of Document Data)

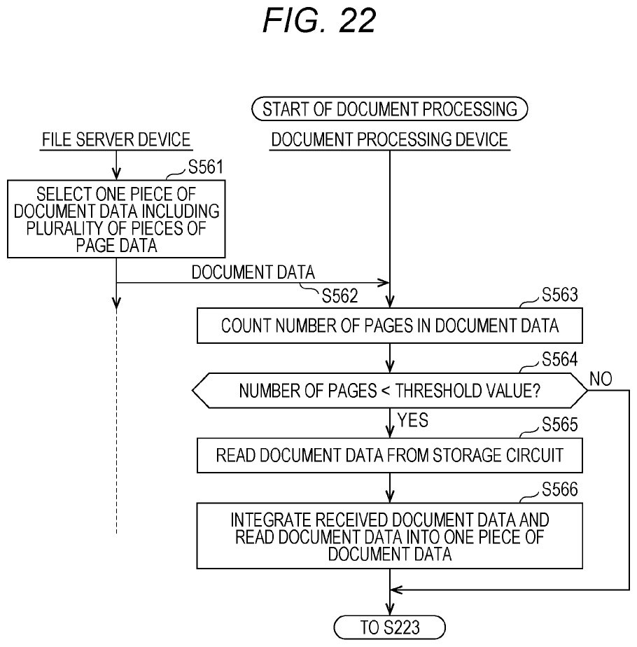

A processing procedure of document data of the first modification will be described with reference to a flowchart illustrated in FIG. 22.

The main controller 211 of the file server device 20 selects one piece of document data (first document data) including a plurality of pieces of page data, from a plurality of pieces of document data stored in the storage circuit 204 (step S561).

The network communication circuit 205 transmits the selected first document data to the document processing device 100 via the network 5. The network communication circuit 105 receives the first document data, and writes the received first document data into the storage circuit 104 (step S562).

The counting part 113d counts a number of pages included in the first document data received and written in the storage circuit 104 (step S563).

The integration controller 112 compares the counted number of pages of the first document data with a threshold value, and judges whether or not the number of pages is less than the threshold value (step S564).

When judging that the number of pages is equal to or larger than the threshold value (“No” in step S564), the integration controller 112 shifts the control to step S223 of the flowchart illustrated in FIG. 11.

When judging that the number of pages is less than the threshold value (“Yes” in step S564), the specification part 113 reads another document data (second document data) from the storage circuit 104 (step S565). Next, the specification part 113 integrates the received first document data and the read second document data into one piece of document data (step S566). Next, the integration controller 112 shifts the control to step S223 of the flowchart illustrated in FIG. 11.

### (Conclusion)

In the first modification, the counting part 113d counts the number of pieces of page data included in the document data.

When the counted number of pieces is less than a predetermined number of pieces, the network communication circuit 105 may further acquire another document data including a plurality of pieces of page data, from the file server device 20 (or an image forming device 30).

The specification part 113 may specify a common object existing at a corresponding position over a predetermined number of pieces or more of page data, from the acquired document data and the newly acquired another document data.

The storage circuit 104 may store the another document data in advance. The main controller 111 (acquisition unit) may acquire the another document data by reading from the storage circuit 104.

As described above, in the first modification, when the number of pages of the first document data is less than a threshold value, the first document data and the another document data (second document data) are integrated to generate one piece of document data (third document data). There is a high possibility that the number of pages of the third document data is equal to or larger than the threshold value, and a common object can be extracted from the third document data.

### 5.4 Second Modification

Here, a second modification of the fifth embodiment will be described focusing on differences from the fifth embodiment.

The storage circuit 104 previously stores another common object and another piece of page data from which the another common object has been extracted in another document data (second document data).

The counting part 113d counts the number of pieces of page data included in the document data.

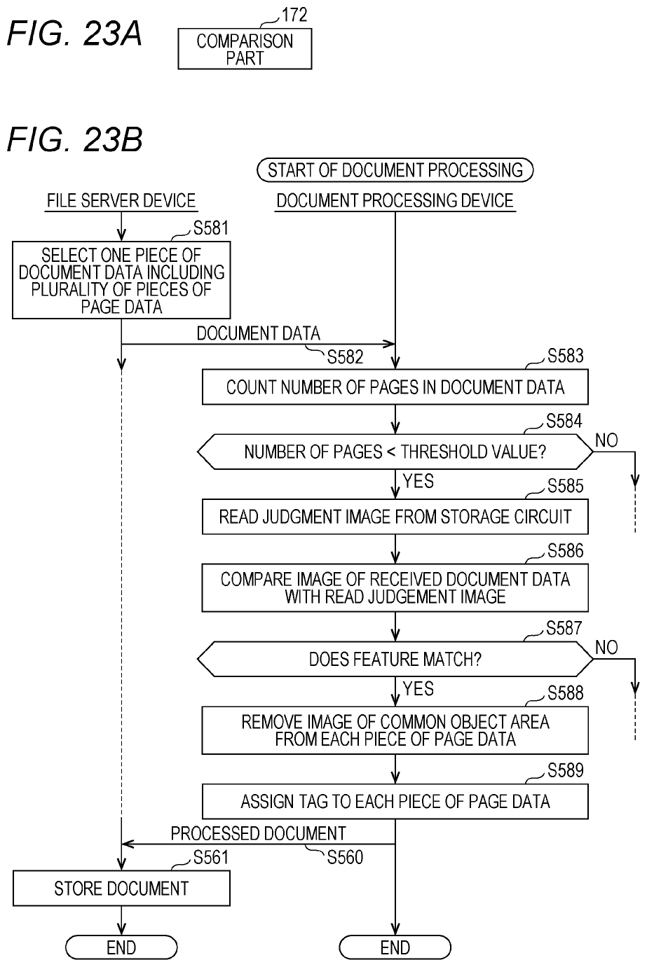

The main controller 111 included in the document processing device 100 of the second modification further includes a comparison part 172 illustrated in FIG. 23A.

When the number of pages of the page data included in the document data (first document data) is less than a threshold value (predetermined number of pages), the comparison part 172 compares a feature of the page data included in the first document data with a feature of another piece of page data of the second document data stored in the storage circuit 104.

In a case where the feature of the page data included in the first document data matches the feature of another piece of page data of the second document data stored in the storage circuit 104, the specification part 113 specifies another common object stored in the storage circuit 104.

### (Processing Procedure of Document Data)

A processing procedure of document data will be described with reference to a flowchart illustrated in FIG. 23B.

The main controller 211 of the file server device 20 selects one piece of document data (first document data) including a plurality of pieces of page data, from a plurality of pieces of document data stored in the storage circuit 204 (step S581).

The network communication circuit 205 transmits the selected first document data to the document processing device 100 via the network 5. The network communication circuit 105 receives the first document data, and writes the received first document data into the storage circuit 104 (step S582).

The counting part 113d counts a number of pages included in the first document data received and written in the storage circuit 104 (step S583).

When judging that the number of pages of the first document data is less than a threshold value (“Yes” in step S584), the comparison part 172 reads page data (judgment image) of another document data (second document data) from the storage circuit 104 (step S585). Next, the comparison part 172 compares a feature of page data of the received first document data with a feature of the read another piece of page data (judgment image) of the second document data (step S586).

When the feature of the page data included in the first document data matches (is similar to) the feature of the read another piece of page data of the second document data (“Yes” in step S587), a removal part 114 reads a common object of the second document data from the storage circuit 104, and removes an image portion of an area corresponding to the read common object, from each piece of page data of the first document data (step S588).

Next, the assignment part 115 adds a tag to each piece of page data of the first document data (step S589).

Next, the network communication circuit 105 transmits the processed first document data to the file server device 20 via the network 5. The network communication circuit 205 receives the first document data (step S560). The network communication circuit 205 stores the received first document data into the storage circuit 204 (step S561).

This is the end of the description of the processing procedure of the document data.

### (Conclusion)

In the second modification, when the number of pages of the first document data is less than the threshold value, a common object of the second document data having a feature that matches (is similar to) a feature of page data of the first document data is removed from each piece of page data of the first document data. Accordingly, even when the number of pages of the first document data is small, the common object can be removed from the first document data.

6. Other Modifications of First to Fifth Embodiments

As other modifications of the first to fifth embodiments, the following may be adopted.

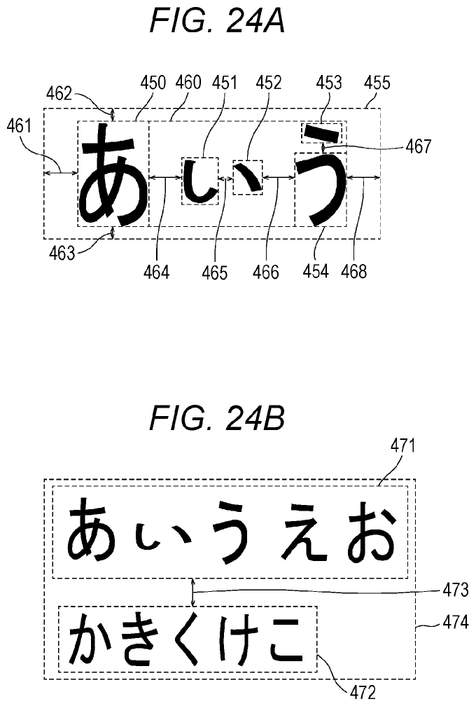

Here, as illustrated in FIG. 24A, it is assumed that areas 450, 451, 452, 453, and 454 each are judged to be common objects. Each of the areas 450, 451, 452, 453, and 454 includes a character or a part of a character.

In addition, it is assumed that a distance 464 between the area 450 and the area 451 is within a predetermined threshold value, and a distance 465 between the area 451 and the area 452 is within a predetermined threshold value. In addition, it is assumed that a distance 466 between the area 452 and the area 454 is within a predetermined threshold value, and a distance 467 between the area 454 and the area 453 is within a predetermined threshold value.

In this case, the areas 450, 451, 452, 453, and 454 may be merged to set a rectangular area 460 circumscribing the areas 450, 451, 452, 453, and 454, and the area 460 may be made as one common object.

Furthermore, an area 455 may be set outside the area 460 by a predetermined distance (distances 461, 462, 463, and 468), and the area 455 may be made as one common object.

Furthermore, as illustrated in FIG. 24B, in a case where an area 471 and an area 472 are common objects, when a distance 473 between the area 471 and the area 472 is within a predetermined threshold value, as illustrated in this figure, the area 471 and the area 472 may be further merged to set a circumscribed rectangular area 474, and the area 474 may be made as one common object.

7. Sixth Embodiment

A document data processing system according to a sixth embodiment will be described.

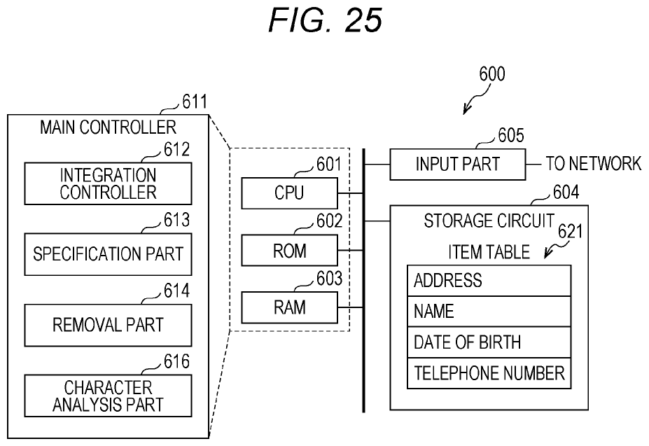

The document data processing system is formed by connecting a document processing device 600 illustrated in FIG. 25 and an image forming device.

The image forming device of the sixth embodiment has the same configuration as the image forming device 30 of the first embodiment.

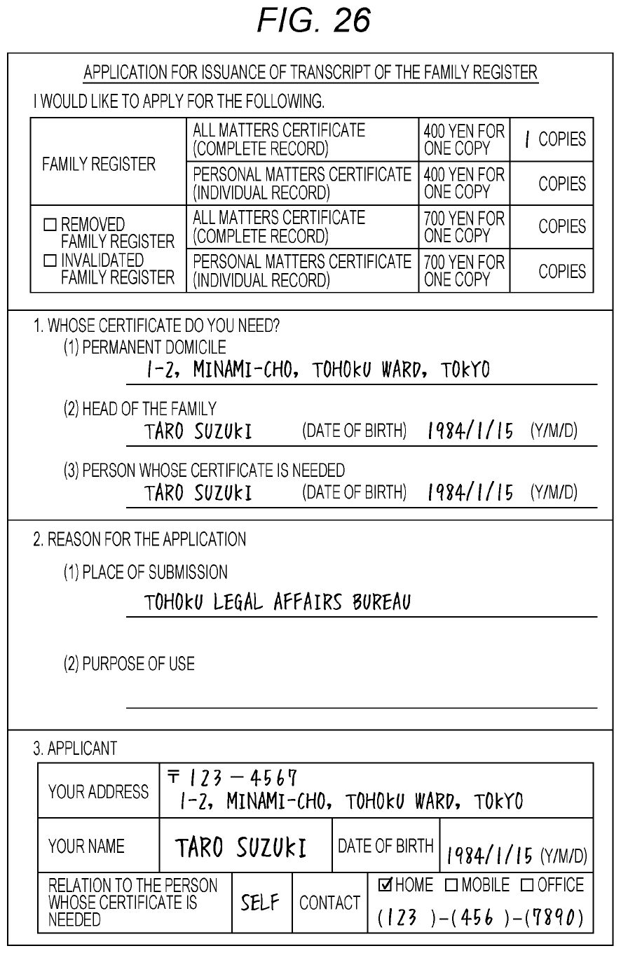

As an example, the image forming device reads a plurality of sheets (application forms) in a fixed format illustrated in FIG. 26 through a user's operation, generates page data as many as the number of pages of the sheet, and transmits the generated page data of the plurality of sheets to the document processing device 600.

As illustrated in FIG. 25, the document processing device 600 includes a CPU 601, a ROM 602, a RAM 603, a storage circuit 604, an input part 605, and the like.

The CPU 601, the ROM 602, and the RAM 603 constitute a main controller 611.

The RAM 603 temporarily stores various control variables and the like, and provides a work area when the CPU 601 executes a program.

The ROM 602 stores a control program (computer program) and the like to be executed in the document processing device 600.

The CPU 601 operates in accordance with the control program stored in the ROM 602.

By the CPU 601 operating in accordance with the control program, the main controller 611 integrally controls the storage circuit 604, the input part 605, and the like.

As described above, similarly to the document processing device 100, the document processing device 600 is a computer system including a microprocessor and a memory.

By the CPU 601 operating in accordance with the control program stored in the ROM 602, the main controller 611 configures an integration controller 612, a specification part 613, a removal part 614, and a character analysis part 616. The specification part 613 and the removal part 614 have configurations similar to those of the specification part 113 and the removal part 114 of the first embodiment, respectively.

The input part 605 is connected to the image forming device. The input part 605 receives a plurality of pieces of page data from the image forming device.

The storage circuit 604 stores in advance an item table 621 indicating items written by handwriting in the application form illustrated in FIG. 26. The item table 621 includes, for example, an address, a name, a date of birth, and a telephone number. The address, the name, the date of birth, and the telephone number correspond to an address, a name, a date of birth, and a telephone number of an applicant of the application form, respectively.

The specification part 613 extracts a common object from a plurality of pieces of page data.

Here, as an example, in the case of the application form illustrated in FIG. 26, the common object is an image portion (excluding a handwritten portion) in which type and a ruled line are printed on the application form.

The removal part 614 removes the extracted common object from the plurality of pieces of page data.

Here, when the extracted common object is removed from the plurality of pieces of page data by the removal part 614, in the case of the application form illustrated in FIG. 26, a handwritten character portion alone excluding the type and ruled line printed on the application form remains on the plurality of pieces of page data.

From the plurality of pieces of page data, the character analysis part 616 analyzes an image of the handwritten character for the remaining handwritten image portion from which the common object has been removed, and generates a corresponding character code. At this time, the image of the handwritten character is analyzed and separated into an address, a name, a date of birth, a telephone number, and the like of the applicant, and each character code is generated. The character analysis part 616 writes the generated character code into the item table 621 in association with each item in the item table 621 of the storage circuit 604, for each address, name, date of birth, telephone number, or the like of the applicant.

As described above, in each piece of page data included in document data, the same fixed format is represented, and handwritten characters are described in this fixed format. The specification part 613 (specification unit) specifies a part of the fixed format as a common object from a plurality of pieces of page data included in the document data. The removal part 614 (removal unit) removes the specified part of the fixed format from each of the plurality of pieces of page data while leaving a part where the handwritten characters are described.

According to the sixth embodiment, handwritten characters written on an application form or the like in a fixed format can be separated and extracted from the fixed format portion.

### 8. Other Modifications (1) Each of the above embodiments and modifications includes an image forming device. However, the present disclosure is not limited to this.

In each of the above embodiments and modifications, instead of the image forming device, an image reading device that reads a document including a plurality of pages and generates image data (document data) may be included. The network communication circuit 105 (acquisition unit) acquires image data from the image reading device.

(2) In each of the above embodiments and modifications, in the document processing device, a search tag is generated and assigned. However, the present disclosure is not limited to this.

In each of the above embodiments and modifications, a search tag may be generated and assigned in the file server device 20.

A document processing device according to the present disclosure is capable of specifying and removing a target that is to be removed from document data, and is useful as a technology for processing the document data.

Although embodiments of the present invention have been described and illustrated in detail, the disclosed embodiments are made for purposes of illustration and example only and not limitation. The scope of the present invention should be interpreted by terms of the appended claims.

What is claimed is:

1. A document processing device for processing document data, the document processing device comprising
a hardware processor that:
acquires document data including a plurality of pieces of page data;
specifies, from the document data, a common object existing at a corresponding position over a predetermined number of pieces or more of page data; and
removes, when a common object is specified, the specified common object from each of the plurality of pieces of page data.

2. The document processing device according to claim 1, wherein
each of the plurality of pieces of page data includes an image in which a plurality of pixels are arranged,
the hardware processor:
generates a superimposed image in which the plurality of pieces of page data are superimposed for each corresponding pixel; and
determines a position where the common object exists in the superimposed image by referring to a spatial density of a pixel having a gradation value in a predetermined range in the superimposed image, and
the hardware processor removes the common object at the determined position.

3. The document processing device according to claim 2, wherein
each of the plurality of pieces of page data includes a plurality of unit areas, and a predetermined number of pixels are arranged in each unit area,
the hardware processor binarizes a gradation value of each pixel in the plurality of pieces of page data, performs an OR operation on binarized gradation values of pixels existing at corresponding positions in the plurality of pieces of page data, and generates, as the superimposed image, an image obtained as an operation result, and
the hardware processor counts, for each unit area in the superimposed image, a number of ON pixels included in the unit area, and, when there is a unit area whose count value is larger than a first threshold value and equal to or smaller than a second threshold value, the hardware processor determines a position where the unit area exists as a position where the common object exists.

4. The document processing device according to claim 2, wherein
each of the plurality of pieces of page data includes a plurality of unit areas, and a predetermined number of pixels are arranged in each unit area,
the hardware processor adds all gradation values of pixels existing at corresponding positions in the plurality of pieces of page data, and generates, as the superimposed image, an image obtained as an addition result, and
when there is a unit area including a gradation value equal to or larger than a threshold value in the superimposed image, the hardware processor determines a position where the unit area exists as a position where the common object exists.

5. The document processing device according to claim 4, wherein
the hardware processor binarizes a gradation value of each pixel in the plurality of pieces of page data, adds all binarized gradation values of pixels existing at corresponding positions in the plurality of pieces of page data, and generates, as the superimposed image, an image obtained as an addition result.

6. The document processing device according to claim 2, wherein
each of the plurality of pieces of page data includes a plurality of unit areas, and a predetermined number of pixels are arranged in each unit area,
the hardware processor generates an initial image including a pixel array with a same arrangement as pixels in the plurality of pieces of page data and having an initial value set to a gradation value of each pixel, the hardware processor subtracts all gradation values of pixels existing at corresponding positions in the plurality of pieces of page data from gradation values of individual pixels in the initial image, and the hardware processor generates, as the superimposed image, an image obtained as a subtraction result; and
when there is a unit area including a gradation value equal to or smaller than a threshold value in the superimposed image, the hardware processor determines a position where the unit area exists as a position where the common object exists.

7. The document processing device according to claim 6, wherein
the hardware processor sets a value of 0 as an initial value of a gradation value of each pixel of the initial image, binarizes a gradation value of each pixel in the plurality of pieces of page data, and subtracts all binarized gradation values of pixels existing at corresponding positions in the plurality of pieces of page data from gradation values of individual pixels in the initial image.

8. The document processing device according to claim 4, wherein
the hardware processor:
counts a number of pieces of page data included in the document data; and
calculates, for each pixel in the plurality of pieces of page data, a normalized gradation value by normalizing a gradation value of the pixel in accordance with the counted number of pieces, and
the hardware processor uses the normalized gradation value in a case of adding a gradation value or subtracting a gradation value.

9. The document processing device according to claim 8, wherein
the hardware processor calculates the normalized gradation value by dividing a gradation value of each pixel in the plurality of pieces of page data by the number of pieces.

10. The document processing device according to claim 1, wherein
each of the plurality of pieces of page data includes a plurality of unit areas, and a predetermined number of pixels are arranged in each unit area,
the hardware processor:
assigns, to each unit area in each piece of page data, a label characterizing the unit area;
assesses whether or not a same label is redundantly assigned to a corresponding unit area over the predetermined number of pieces or more of page data; and
determines a position where the unit area exists as a position where the common object exists, by using a number of times that the hardware processor assesses that there is redundancy, and
the hardware processor removes the common object at the determined position.

11. The document processing device according to claim 10, wherein
each of the plurality of pieces of page data includes an image in which a plurality of pixels are arranged,
the hardware processor judges, for each unit area in the plurality of pieces of page data, whether or not a gradation value of a pixel included in the unit area is equal to or larger than a predetermined threshold value, assigns a label indicating an ON pixel area to the unit area when a gradation value of at least one pixel is equal to or larger than a threshold value, and assigns a label indicating an OFF pixel area to the unit area when gradation values of all pixels included in the unit area are less than a threshold value.

12. The document processing device according to claim 10, wherein
each of the plurality of pieces of page data includes a color image in which a plurality of pixels are arranged, and
the hardware processor specifies, for each unit area in the plurality of pieces of page data, a representative color representing a color of a plurality of pixels included in the unit area by using gradation values of a plurality of pixels included in the unit area, and assigns the specified representative color as a label characterizing the unit area.

13. The document processing device according to claim 10, wherein
the hardware processor includes a counter for each unit area, assesses whether or not there is redundancy between a label assigned to one unit area in first page data in the document data and a label assigned to a corresponding unit area in other page data, and adds a predetermined value to a counter of the unit area or subtracts a predetermined value from the counter every time assessing that there is redundancy, and
when an absolute value of a counter value of a unit area is equal to or larger than a predetermined threshold value after redundancy assessment for all labels is ended, the hardware processor determines a position where the unit area exists as a position where the common object exists.

14. The document processing device according to claim 1, wherein
each of the plurality of pieces of page data includes a plurality of unit areas, and a predetermined number of pixels are arranged in each unit area,
the hardware processor:
extracts, for each unit area of each piece of page data, a feature in the unit area, merges a plurality of unit areas into one enlarged area when a same feature exists in the plurality of unit areas that are adjacent, and assigns one label indicating a common feature to the enlarged area;
assesses whether or not a same label is redundantly assigned to a corresponding enlarged area over the predetermined number of pieces or more of page data; and
determines a position where the enlarged area exists as a position where the common object exists, by using a number of times that the hardware processor assesses that there is redundancy, and
the hardware processor removes the common object at the determined position.

15. The document processing device according to claim 1, wherein
each of the plurality of pieces of page data includes a plurality of unit areas, and a predetermined number of pixels are arranged in each unit area,
the hardware processor:
judges, for each unit area in the plurality of pieces of page data, whether or not a gradation value of a pixel included in the unit area is equal to or larger than a predetermined threshold value, sets the unit area as an ON pixel area when a gradation value of at least one pixel is equal to or larger than a threshold value, merges, when another ON pixel area is adjacent to the unit area, the another ON pixel area adjacent to the unit area, generates a merged area including a circumscribed rectangle surrounding an area that has been merged, acquires a size of the generated merged area, and assigns the acquired size to the merged area as a label characterizing the merged area;
assesses whether or not a same label is redundantly assigned to a corresponding merged area over the predetermined number of pieces or more of page data; and
determines a position where the merged area exists as a position where the common object exists, by using a number of times that the hardware processor assesses that there is redundancy, and
the hardware processor removes the common object at the determined position.

16. The document processing device according to claim 1, wherein
each of the plurality of pieces of page data includes an image in which a plurality of pixels are arranged,
the hardware processor:
generates a superimposed image in which the plurality of pieces of page data are superimposed for each corresponding pixel;
performs OCR processing on the superimposed image to extract a character string from the superimposed image;
judges, when a character string is extracted by the hardware processor, whether or not the extracted character string is a specific character string; and
determines, when the extracted character string is judged to be a specific character string, a position where the character string exists in the page data as a position where the common object exists, and
the hardware processor removes the common object at the determined position.

17. The document processing device according to claim 16, wherein
the hardware processor binarizes a gradation value of each pixel in the plurality of pieces of page data, and performs an OR operation on binarized gradation values of pixels existing at corresponding positions in the plurality of pieces of page data to generate the superimposed image.

18. The document processing device according to claim 1, wherein
the hardware processor:
judges whether or not the specified common object has a specific shape; and
merges, into the common object, an object existing within a predetermined distance from the common object in the page data, when it is determined that the common object has a specific shape.

19. The document processing device according to claim 1, wherein
the hardware processor:
counts a number of pieces of page data included in the document data; and
suppresses specification of a common object by the hardware processor when the counted number of pieces is less than a predetermined number of pieces.

20. The document processing device according to claim 19, wherein
the hardware processor outputs judgment information indicating that there is no common object, when the counted number of pieces is less than a predetermined number of pieces.

21. The document processing device according to claim 1, wherein
the hardware processor counts a number of pieces of page data included in the document data,
when the counted number of pieces is less than a predetermined number of pieces, the hardware processor further acquires another document data including a plurality of pieces of page data, and
the hardware processor further specifies a common object existing at a corresponding position over a predetermined number of pieces or more of page data, from both the document data and the another document data.

22. The document processing device according to claim 21, further comprising:
a storage that stores the another document data, wherein
the hardware processor acquires the another document data by reading from the storage.

23. The document processing device according to claim 1, further comprising:
a storage that stores another common object and another piece of page data in which the another common object is previously specified in another document data, wherein
the hardware processor:
counts a number of pages included in the document data acquired by the hardware processor; and
compares a feature of page data included in the acquired document data with a feature of the another piece of page data stored in the storage when the counted number of pages is less than the predetermined number of pieces, and
when a feature of page data included in the acquired document data matches a feature of the another piece of page data stored in the storage, the hardware processor specifies, as the common object, the another common object stored in the storage.

24. The document processing device according to claim 1, wherein
an image reading device or a server device is connected to the document processing device,
the image reading device generates the document data by reading a document including a plurality of pages, and the hardware processor acquires the document data from the image reading device, and
the server device stores the document data, and the hardware processor acquires the document data by receiving the document data from the server device.

25. The document processing device according to claim 1, wherein
in each piece of page data included in the document data, a fixed format that is same is represented, and a handwritten character is described in the fixed format, and
the hardware processor specifies a part of the fixed format as the common object, from a plurality of pieces of page data included in the document data, and
the hardware processor removes the specified part of the fixed format from each of a plurality of pieces of page data, while leaving a part where a handwritten character is described.

26. A system comprising the document processing device according to claim 1 and a retrieval device, wherein
the hardware processor:
receives, from the document processing device, the document data in which the common object has been removed from each of the plurality of pieces of page data, and receives, from an information terminal, a search condition for searching for document data;
searches for document data matching the received search condition from a plurality of pieces of document data including the received document data; and
transmits a search result obtained by the hardware processor to the information terminal.

27. A document processing method used in a document processing device that processes document data, the document processing method comprising:
acquiring document data including a plurality of pieces of page data;
specifying, from the document data, a common object existing at a corresponding position over a predetermined number of pieces or more of page data; and
removing, when a common object is specified, the specified common object from each of the plurality of pieces of page data.

28. A non-transitory recording medium storing a computer readable computer program used in a document processing device that processes document data, the computer readable computer program being for performing document processing and causing
the document processing device that is a computer to execute:
acquiring document data including a plurality of pieces of page data;
specifying, from the document data, a common object existing at a corresponding position over a predetermined number of pieces or more of page data; and
removing, when a common object is specified, the specified common object from each of the plurality of pieces of page data.
